(19) United States
(12) Patent Application Publication
(10) Pub. No.: US 2023/0056255 A1
(43) Pub. Date: Feb. 23, 2023

(54) DENTAL TOOL

(71) Applicant: Jui Yuan SHIH, Changhua County (TW)

(72) Inventor: Jui Yuan SHIH, Changhua County (TW)

(21) Appl. No.: 17/885,938

(22) Filed: Aug. 11, 2022

(30) Foreign Application Priority Data
Aug. 18, 2021 (TW) 110130529

(51) Int. Cl. A61C 19/04; A61C 1/14

(52) U.S. Cl. CPC A61C 19/043; A61C 19/041; A61C 1/145; A61C 1/147; A61C 2201/007

(57) ABSTRACT

A dental tool has a body and a working element. The body has a connecting portion and a measuring portion. The connecting portion is disposed on an end of the body. The measuring portion is formed on an external surface of the body opposite to the connecting portion. The working element is connected to the body and has a connecting end and a working end. The connecting end of the working element is connected to the connecting portion of the body. The working end of the working element is connected to the connecting end of the working element and extends out of the connecting portion. The working element of the dental tool provides a detection effect, and the measuring portion of the body provides a measurement effect.

### BACKGROUND OF THE INVENTION

### 1. Field of the Invention

The present invention relates to a dental tool, and more particularly to a dental tool that may provide a measurement effect, may improve inspection experience, and is convenient in use.

### 2. Description of Related Art

At present, there are quite a few tools used in dental clinics, such as explorers, mirrors, pliers and other instruments, which are frequently used tools in the process of dental inspection or treatment. Among them, explorers mainly provide dentists with tactile examination and determination of whether there is any abnormality in the patient's teeth, such as the depth of the periodontal pocket, the thickness of the gum, the looseness of the teeth, and the gap width of the teeth, etc. A conventional explorer has a rod-shaped handle and one or two needles disposed on an end or two ends of the conventional explorer, and each one of the needles is used as a working end. The dentist may inspect the patient's teeth by holding the handle and using the needles of the conventional explorer to inspect the patient's teeth. However, the conventional explorer only has a single effect of detecting teeth, and cannot provide other uses and effects.

In addition, when a patient needs dental implants, conventional surgical guides corresponding to the patient's tooth positions need to be manufactured as the measurement benchmark for subsequent drilling, dental implant (artificial root implantation), etc., which can only be used by a specific and single patient, and cannot be applied to other patients. Furthermore, the production cost is high, which relatively limits the applicability, practicability and economy of the conventional surgical guides.

Further, the needles of the conventional explorer are made of stainless steel, and have a certain structural strength. The needles cause discomfort to the patient when probing teeth, and when the conventional explorer falls to the ground or collides with other objects, the needles will be bent or deformed, which will affect the subsequent reusability. When the needle of the conventional explorer is inserted into a posterior area of an upper jaw of the patient via a drilling hole of the alveolar bone, if the dentist does not pay attention, the needle may puncture the patient's sinus membrane. When the bone graft is filled in the alveolar bone, the bone graft will enter the sinus cavity via the broken sinus membrane, which may lead to infection and suppuration in the sinus cavity, resulting in infection of the maxillary sinus. In severe cases, the bacteria will spread into the brain, causing damage to the brain and affecting life safety. Therefore, the conventional explorer needs to be improved.

To overcome the shortcomings, the present invention tends to provide a dental tool to mitigate the aforementioned problems.

### SUMMARY OF THE INVENTION

The main objective of the invention is to provide a dental tool that may provide a measurement effect, may improve inspection experience, and is convenient in use.

A dental tool in accordance with the present invention has a body and a working element. The body has a connecting portion and a measuring portion. The connecting portion is disposed on an end of the body. The measuring portion is formed on an external surface of the body opposite to the connecting portion. The working element is connected to the body and has a connecting end and a working end. The connecting end of the working element is connected to the connecting portion of the body. The working end of the working element is connected to the connecting end of the working element and extends out of the connecting portion. The working element of the dental tool provides a detection effect, and the measuring portion of the body provides a measurement effect.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a dental tool in accordance with the present invention;

FIG. 2 is a side view of the dental tool in FIG. 1;

FIG. 3 is an enlarged side view of the dental tool in FIG. 2 at a circle A;

FIG. 4 is an enlarged side view of the dental tool in FIG. 2 at a circle B;

FIGS. 5 to 10 are operational perspective views of the dental tool in FIG. 1;

FIG. 11 is a side view of a second embodiment of a dental tool in accordance with the present invention;

FIG. 12 is a side view of a third embodiment of a dental tool in accordance with the present invention;

FIG. 13 is a side view of a fourth embodiment of a dental tool in accordance with the present invention;

FIG. 14 is an enlarged side view of a fifth embodiment of a dental tool in accordance with the present invention;

FIG. 15 is another enlarged side view of the dental tool in FIG. 14;

FIG. 16 is a perspective view of a sixth embodiment of a dental tool in accordance with the present invention;

FIG. 17 is an enlarged and exploded perspective view of the dental tool in FIG. 16;

FIG. 18 is an enlarged side view in partial section of the dental tool in FIG. 16;

FIG. 19 is an enlarged and exploded perspective view of a seventh embodiment of a dental tool in accordance with the present invention;

FIG. 20 is an enlarged side view of an eighth embodiment of a dental tool in accordance with the present invention;

FIG. 21 is an enlarged side view of a ninth embodiment of a dental tool in accordance with the present invention;

FIG. 22 is another enlarged side view of the dental tool in FIG. 21;

FIG. 23 is an enlarged side view of a tenth embodiment of a dental tool in accordance with the present invention;

FIG. 24 is an enlarged and exploded side view of the dental tool in FIG. 23;

FIG. 25 is a perspective view of an eleventh embodiment of a dental tool in accordance with the present invention;

FIG. 26 is an enlarged side view of the dental tool in FIG. 25;

FIG. 27 is a side view of a twelfth embodiment of a dental tool in accordance with the present invention;

FIG. 28 is a side view of a thirteenth embodiment of a dental tool in accordance with the present invention;

FIG. 29 is an enlarged cross sectional side view of a fourteenth embodiment of a dental tool in accordance with the present invention;

FIG. 30 is an enlarged cross sectional side view of a fifteenth embodiment of a dental tool in accordance with the present invention;

FIG. 31 is an enlarged side view in partial section of a sixteenth embodiment of a dental tool in accordance with the present invention;

FIG. 32 is an enlarged cross sectional side view of a seventeenth embodiment of a dental tool in accordance with the present invention;

FIG. 33 is an enlarged side view in partial section of an eighteenth embodiment of a dental tool in accordance with the present invention;

FIG. 34 is an enlarged and exploded perspective view of the dental tool in FIG. 33;

FIG. 35 is a side view of a nineteenth embodiment of a dental tool in accordance with the present invention;

FIG. 36 is an enlarged and exploded side view in partial section of a twentieth embodiment of a dental tool in accordance with the present invention;

FIG. 37 is a side view in partial section of a twenty-first embodiment of a dental tool in accordance with the present invention;

FIG. 38 is an enlarged and exploded side view in partial section of a twenty-second embodiment of a dental tool in accordance with the present invention;

FIG. 39 is a side view in partial section of a twenty-third embodiment of a dental tool in accordance with the present invention; and

FIG. 40 is an enlarged and exploded side view in partial section of a twenty-fourth embodiment of a dental tool in accordance with the present invention.

### DETAILED DESCRIPTION OF PREFERRED EMBODIMENTS

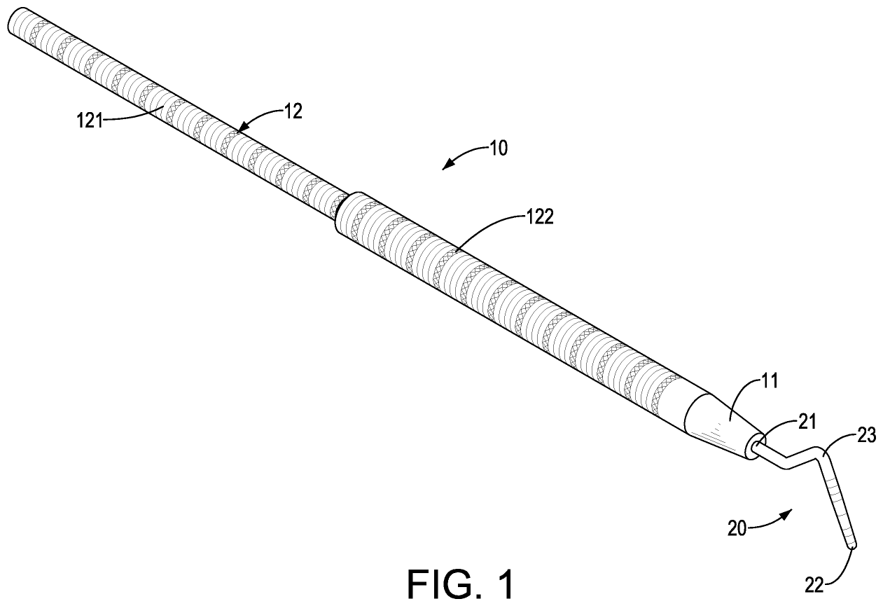

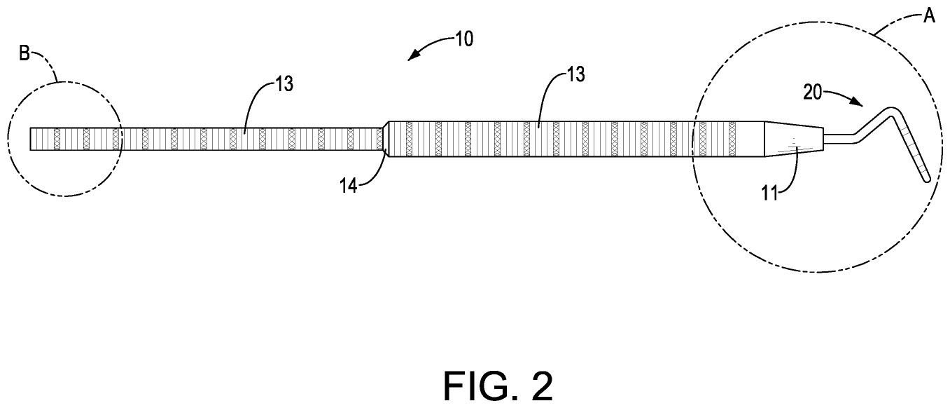

With reference to FIGS. 1 to 4, a first embodiment of a dental tool in accordance with the present invention comprises a body 10 and a working element 20.

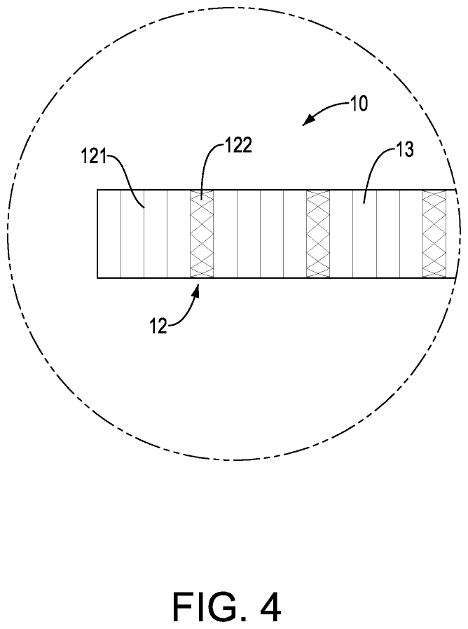

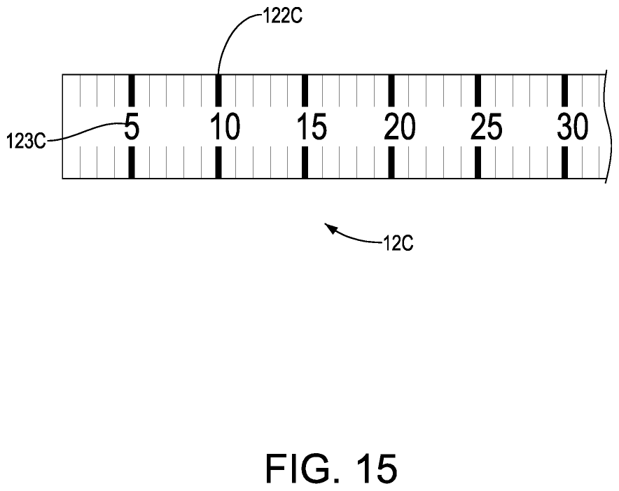

The body 10 is an elongated rod, and a cross-section of the body 10 can be rectangular, circular, triangular, square, hexagonal or polygonal, can be in a flat shape, allowing a user to hold the body 10, and can provide a stable holding effect. The body 10 has a connecting portion 11 and a measuring portion 12. The connecting portion 11 is disposed on an end of the body 10. The measuring portion 11 is formed on an external surface of the body 10 opposite to the connecting portion 11 and can be a size scale formed on the external surface of the body 10 by laser, machining or coating. With reference to FIG. 4, a graduated scale 12 is formed on the external surface of the body 10 every 1 millimeter (mm), and a mark 12 is formed on the external surface of the body 10 every 5 millimeters (mm). The mark 122 can be a mesh notch or an obvious trace notch, and a number mark as shown in FIG. 15 can be set at each of the marks 122, so that a user can quickly obtain the corresponding size value. The graduated scales 121 and the marks 122 of the measuring portion 12 not only allow the body 10 to have the function of measuring size, but also increase the frictional force of the user to hold the body 10 and improve the stable holding effect. Preferably, the body 10 has two rod portions 13, and the two rod portions 13 are connected to each other and have different outer diameters, so that a stepped face 14 is formed at a connecting location between the two rod portions 13, and the measuring portion 12 is formed on outer surfaces of the two rod portions 13.

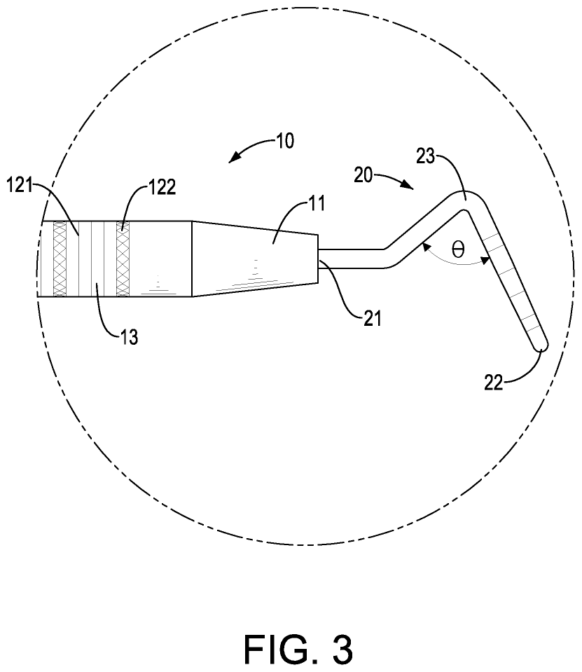

With reference to FIGS. to 3, the working element 20 is connected to the body 10 and has a connecting end 21 and a working end 22. The connecting end 21 of the working element 20 is connected to the connecting portion 11 of the body 10. The working end 21 of the working element 20 is connected to the connecting end 21 of the working element 20 and extends out of the connecting portion 11. Furthermore, the working element 20 may be a rod made of Shape Memory Alloys (SMA) to have physical properties of shape memory and pseudo-elasticity. In addition, the working element 20 may be a rod made of stainless steel, titanium alloys, platinum or tungsten. Preferably, with reference to FIG. 3, the working element 20 has a curved portion 23 formed between the connecting end 21 and the working end 22 with an included angle ⊖.

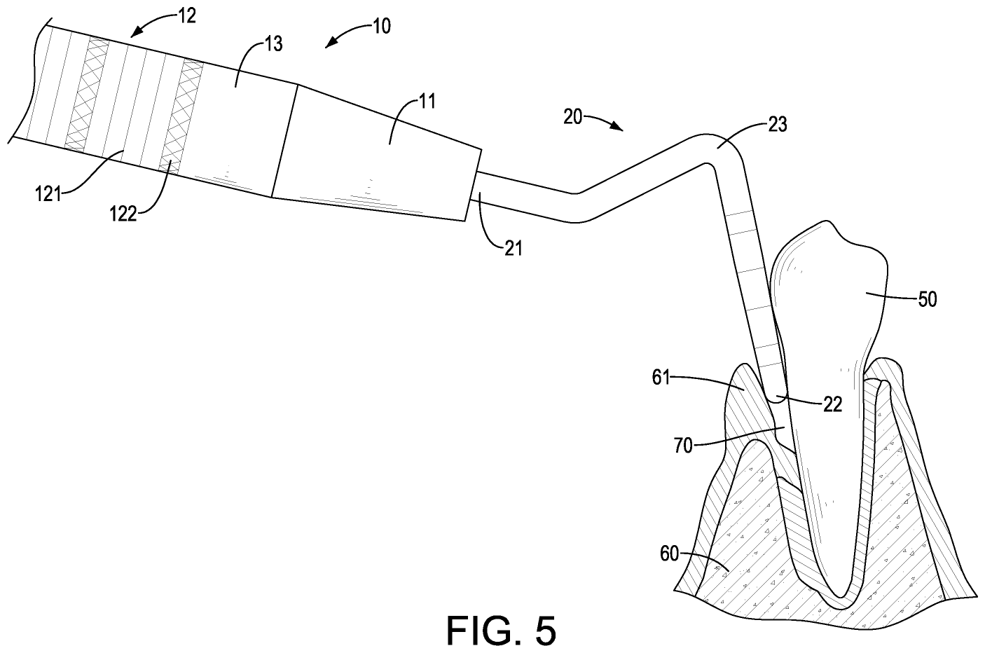

According to the above-mentioned features and structural relationships of the present invention, the first embodiment of the dental tool is an explorer, with reference to FIG. 5, a dentist can hold the body 10 and detect the status of the patient's gums, periodontal pockets, etc., so as to detect and inspect the relevant conditions of the patient's gums or periodontal pockets via the working end 22 of the working element 20. The working end 22 of the working element 20 can be inserted into a gap between the patient's teeth 50 and the gum 61 (located outside the alveolar bone 60) to confirm a depth of the periodontal pocket 70. Since the working element 20 is made of shape memory alloy, in the process of detecting the periodontal pocket 70, the working element 20 can be elastically deformed in response to the force exerted by the dentist, effectively avoiding excessive force that causes the patient's discomfort during consultation. Furthermore, since the working element 20 is made of shape memory alloy, stainless steel, titanium alloy, platinum or tungsten, when the explorer falls to the ground or collides with other objects, the working end 22 of the working element 20 can respond to the external force, after elastic bending or deformation, the working end 22 will be returned to the original state, which will not affect subsequent reuse. In addition, the dental tool of the present invention can also be used to detect bone defects around dental implants and gums after dental implants.

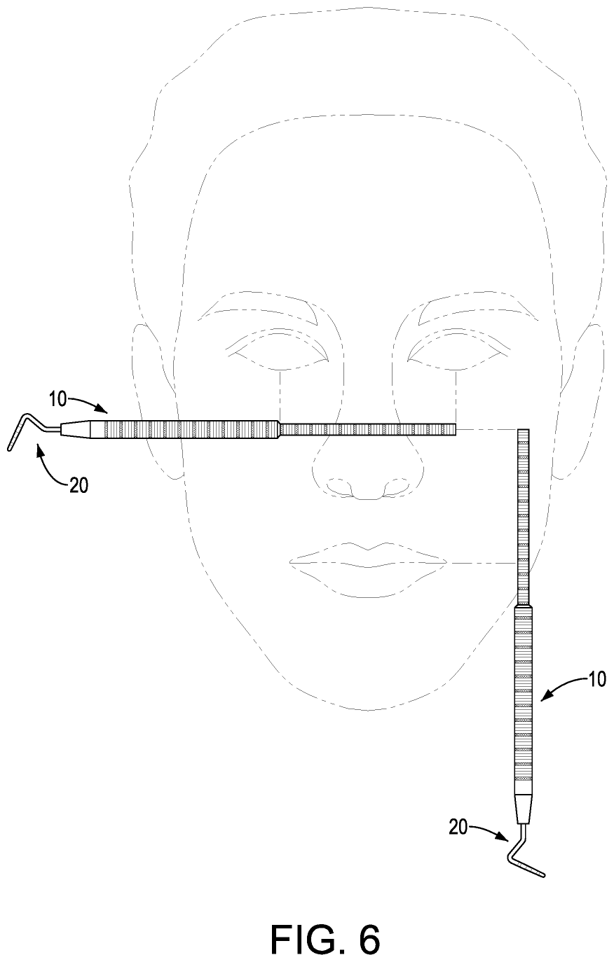

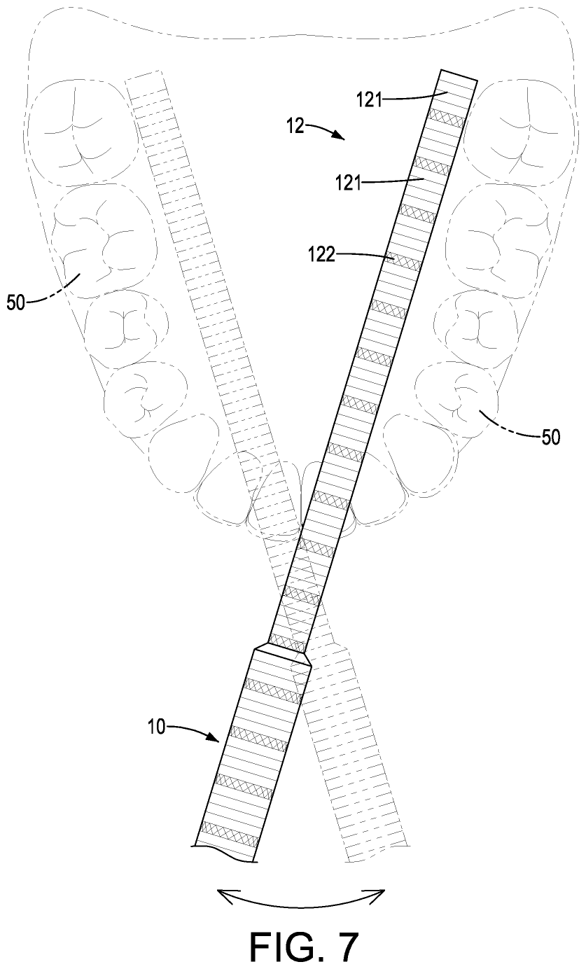

With reference to FIG. 6, the explorer of the first embodiment of the present invention can provide a detection effect, the measuring portion 12 on the body 10 can further allow the dentists to measure relative position and distance of the patient's face, such as biometric features, to provide the basis for subsequent related medical diagnosis. Further, with reference to FIG. 7, in the first embodiment of the present invention, in a process of dental implantation, the data obtained by the dentist through X-ray film or tomography, each referenced point in the patient's oral cavity (for example: the relative position of the adjacent teeth 50, etc.) is measured and positioned for subsequent drilling or implantation of dental implants 80 via the measuring portion 12 of the body 10 and the actual situation inside the patient's oral cavity.

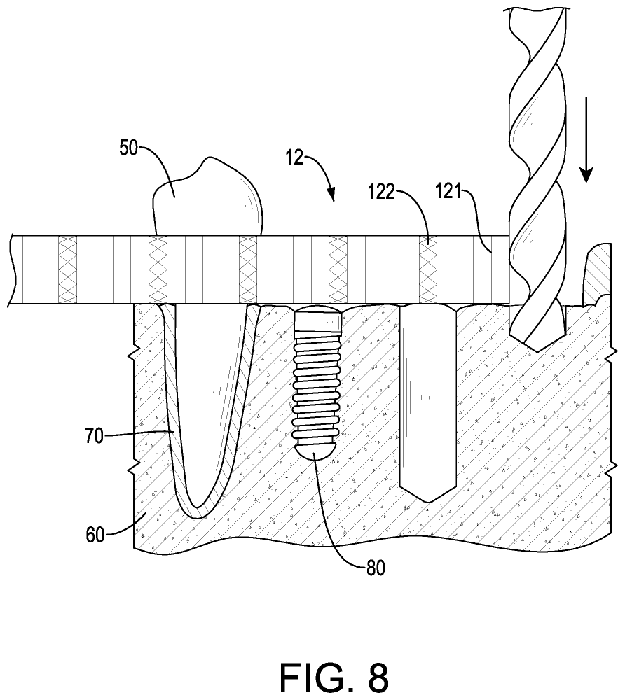

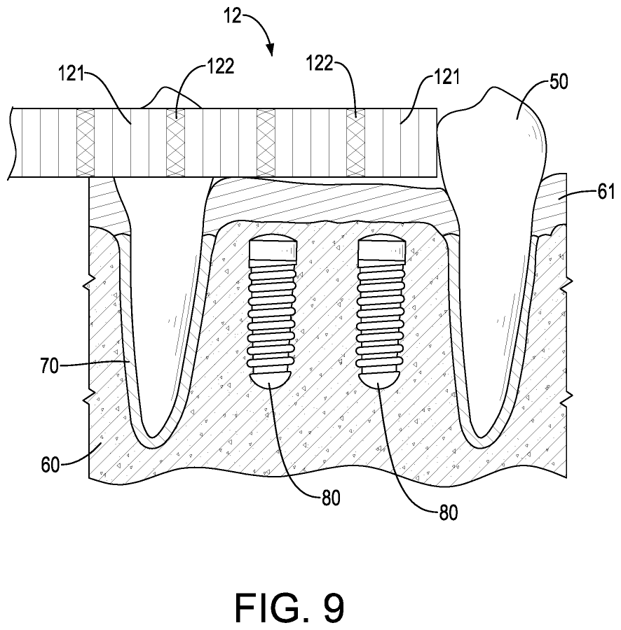

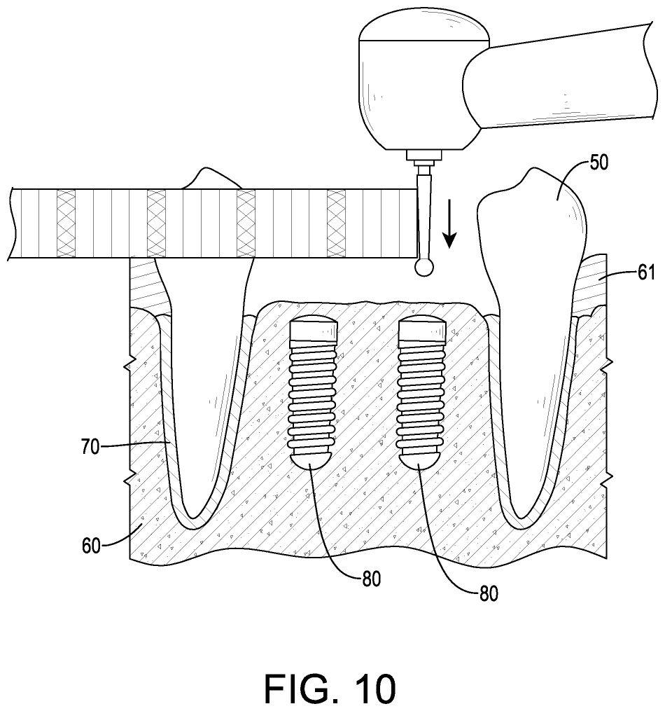

Additionally, after the dentist inspects and measures the position of the teeth 50 in the patient's oral cavity as shown in FIG. 7, the explorer can be used in multiple surgical stages of subsequent dental implants. With reference to FIG. 8, a healthy tooth 50 is used as a reference, and the graduated scale 121 and the mark 122 of the measuring portion 12 of the body 10 are used to measure and locate a position to be drilled. After drilling, the dental implant 80 is implanted in the drilled hole (the first operation stage), whereby the drilling and the implantation of the dental implants 80 are performed (in an order from right to left in FIG. 8). Additionally, after the dental implants 80 are implanted and the bone graft is filled, the filled bone graft will grow new bone on the alveolar bone 60 as shown in FIG. 9 and may completely cover upper surfaces and outsides of the dental implants 80. With reference to FIG. 10, when the dentist wants to combine dental crowns with the dental implants 80, the dentist can accurately locate the positions of each one of the dental implants 80 via the measuring portion 12 on the body 10 (the second operation stage), and can avoid cutting or drilling the positions that do not correspond to the dental implants 80. It not only can improve the surgical quality of implant, but also can accurately combine the dental crowns with the dental implants 80, so that the explorer of the present invention can have dual effects of detection and measurement, and can replace the use of the conventional surgical guides, thereby providing the effects of convenient use and cost saving.

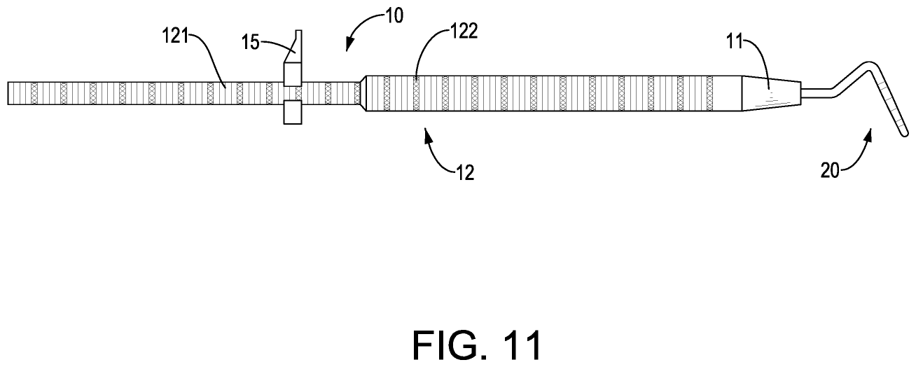

With reference to FIG. 11, a second embodiment of a dental tool in accordance with the present invention is substantially the same as the first embodiment as shown in FIGS. 1 to 4 except for the following features. In the second embodiment of the present invention, the body 10 has a cursor element mounted around one of the two rod portions 13, and the cursor element 15 can be moved relative to the corresponding rod portion 13 and can be aligned with one of the graduated scales 121 or the marks 122 to allow users to clearly read the corresponding size values.

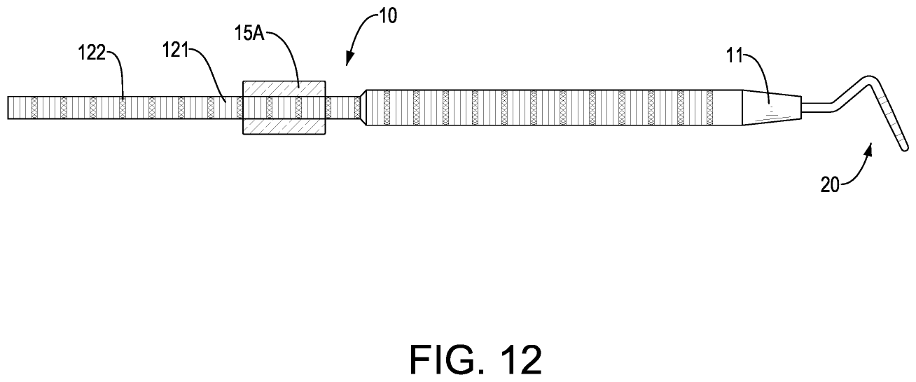

With reference to FIG. 12, a third embodiment of a dental tool in accordance with the present invention is substantially the same as the second embodiment as shown in FIG. 11 except for the following features. In the third embodiment of the present invention, the cursor element 15A is a tube mounted around the body 10, and a user can measure sizes by moving the tube relative to the body 10. In the second and third embodiments of the present inventions, the cursor elements 15, 15A can abut against reference points such as a heathy tooth 50 or a dental implant 80 as shown in FIGS. 7 and 8 to provide the effect of positioning and measurement.

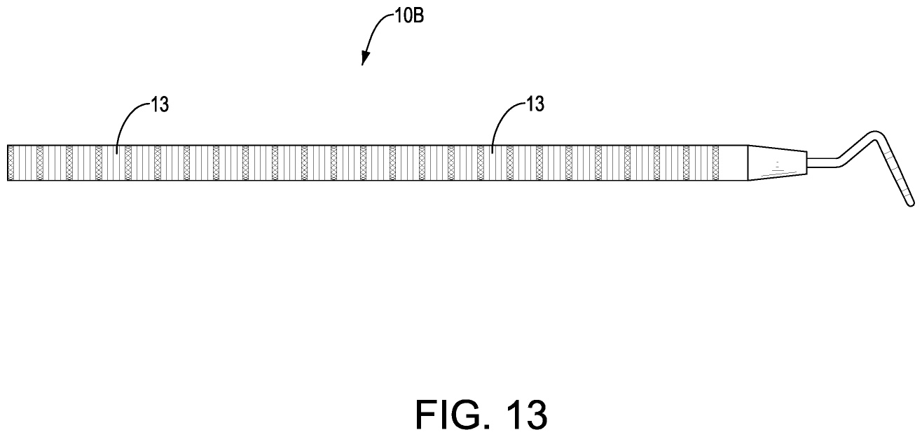

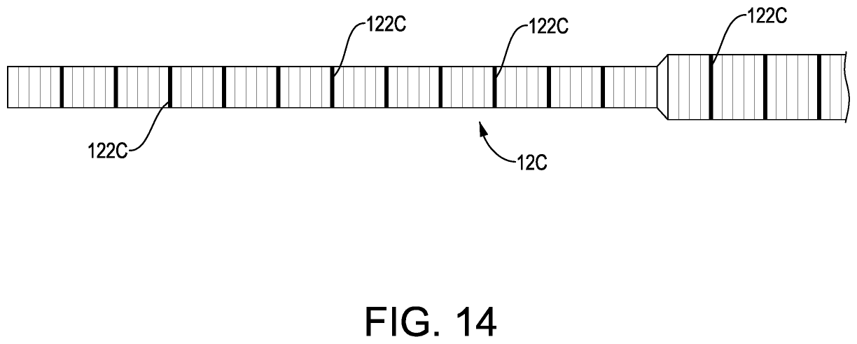

With reference to FIG. 13, a fourth embodiment of a dental tool in accordance with the present invention is substantially the same as the first embodiment as shown in FIGS. 1 to 4 except for the following features. In the fourth embodiment of the present invention, the two rod portions 13B of the body 10B have equal outer diameters such that the body 10B has a single outer diameter. With reference to FIG. 14, a fifth embodiment of a dental tool in accordance with the present invention is substantially the same as the first embodiment as shown in FIGS. 1 to 4 except for the following features. In the fifth embodiment of the present invention, each mark 122C of the measuring portion 12C is a bold notch. In addition, with reference to FIG. 15, in the fifth embodiment of the present invention, each mark 122C has a number mark 123C to allow users to quickly get corresponding size values.

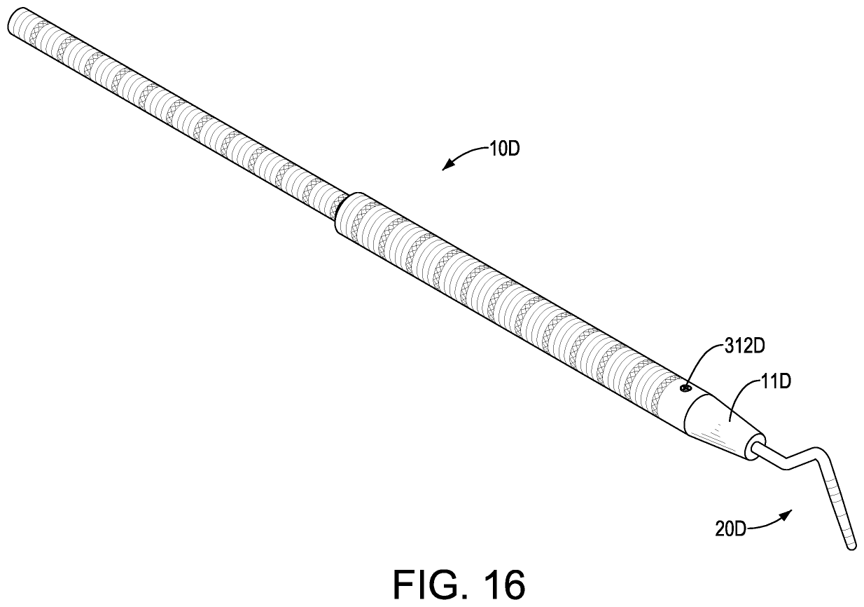

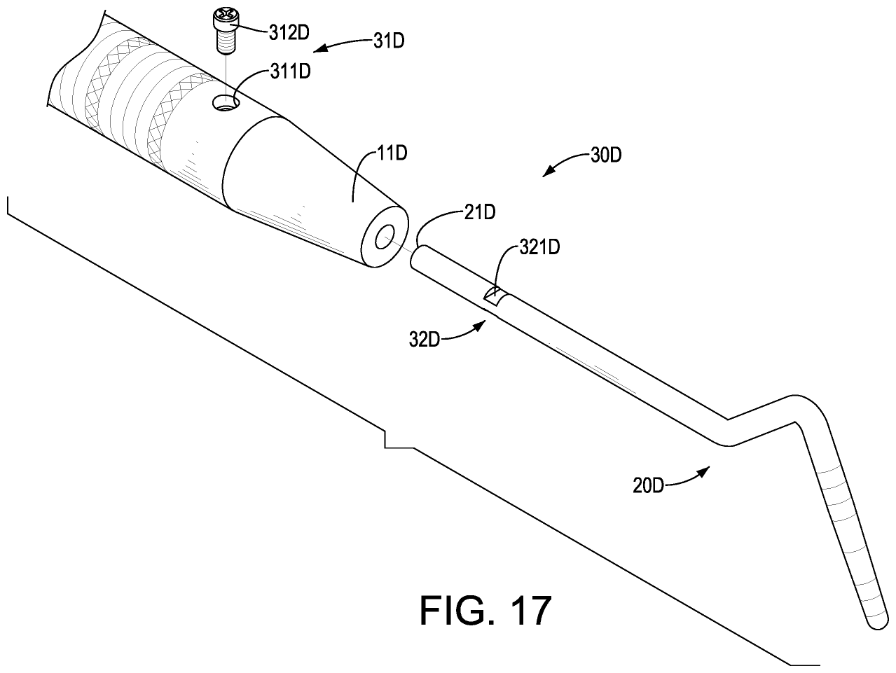

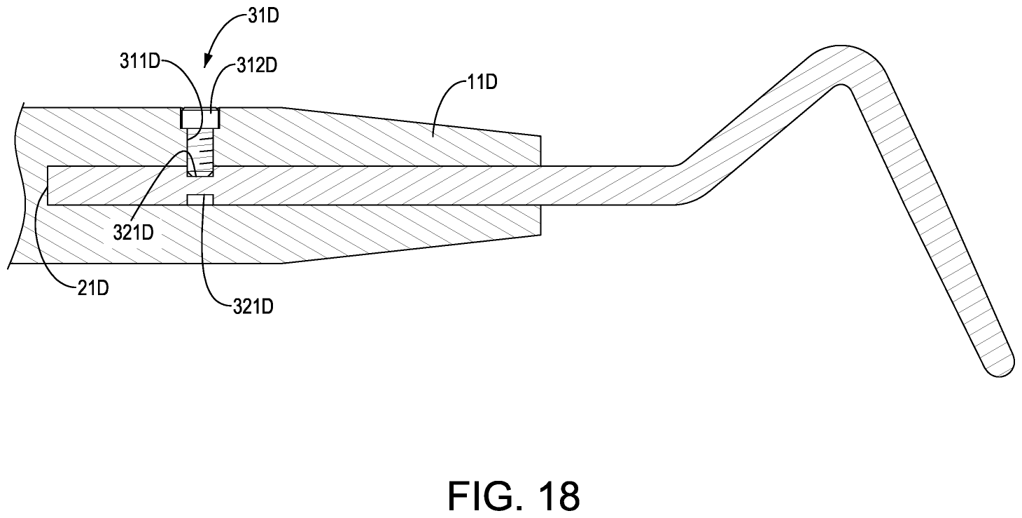

With reference to FIGS. 16 to 18, a sixth embodiment of a dental tool in accordance with the present invention is substantially the same as the first embodiment as shown in FIGS. 1 to 4 except for the following features. In the sixth embodiment of the present invention, the dental tool has a fixing mechanism 30D disposed between the body 10D and the working element 20D, and the fixing mechanism 30D has a fixing unit 31D and an engaging unit 32D. The fixing unit 31D is disposed on the connecting portion 11D of the body 10D and has a fixing hole 311D and a fixing element 312D. The fixing hole 311D is radially formed in the connecting portion 11D and communicates with an interior of the connecting portion 11D. The fixing element 312D is connected to the fixing hole 311D and extends into the interior of the connecting portion 11D. The engaging unit 32D is disposed on the working element 20D adjacent to the connecting end 21D and has at least one engaging face 321D. The at least one engaging face 321D is formed on an external surface of the working element 20D, extends into the interior of the connecting portion 11D via the connecting end 21D, and aligns with the fixing hole 311D. The fixing element 312D engages with the at least one engaging face 321D via the fixing hole 311D. Then the working element 20D is securely connected to the body 10 by the fixing mechanism 30D. Preferably, the engaging unit 32D has two engaging faces 321D parallelly formed on the external surface of the working element 20D, and the fixing element 312D engages with one of the two engaging faces 321D.

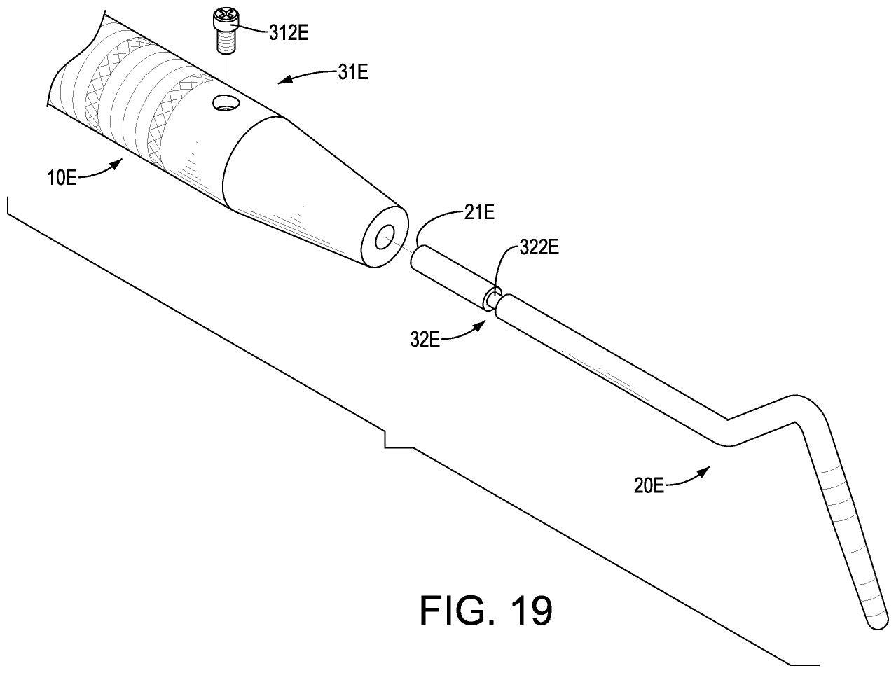

With reference to FIG. 19, a seventh embodiment of a dental tool in accordance with the present invention is substantially the same as the sixth embodiment as shown in FIGS. 16 to 18 except for the following features. In the seventh embodiment of the present invention, the engaging unit 32E has an engaging annular face 322E formed on the external surface of the working element 20E adjacent to the working end 21E, and the fixing element 312E of the fixing unit 31E engages with the engaging annular face 322E to connect the working element 20E securely with the body 10E.

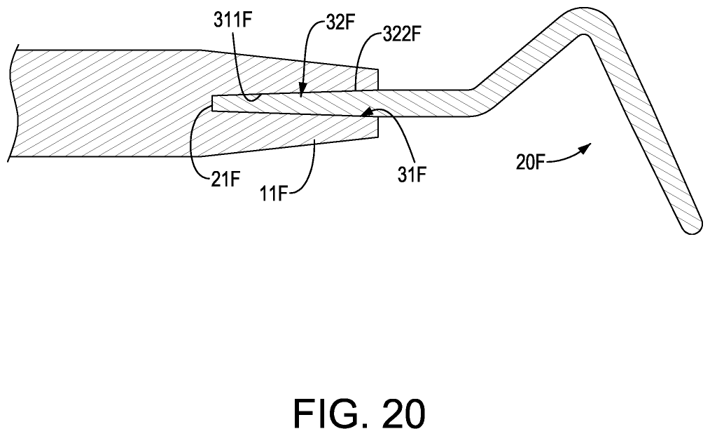

With reference to FIG. 20, an eighth embodiment of a dental tool in accordance with the present invention is substantially the same as the sixth embodiment as shown in FIGS. 16 to 18 except for the following features. In the eighth embodiment of the present invention, the fixing hole 311F of the fixing unit 31F is axially formed in the connecting portion 11F and is a tapered groove that gradually expands from the inside to the outside. The engaging unit 32F is disposed on the external surface of the working element 20F adjacent to the connecting end 21F and has a tapered engaging annular face 322F engaged with the fixing hole 311F. In addition, the tapered engaging annular face 322F can be securely connected to the fixing hole 311F by laser welding, arc welding, electron beam welding, friction welding, copper-tin welding, interference combination of thermal expansion and cold contraction or coating of adhesives.

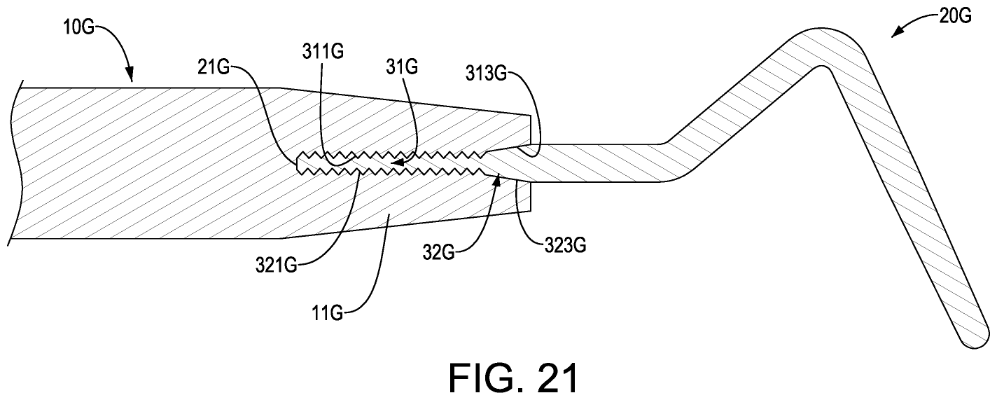

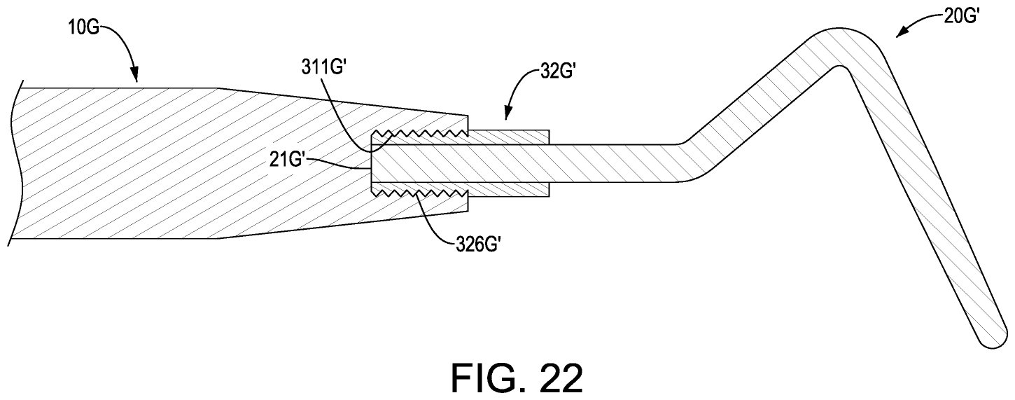

With reference to FIG. 21, a ninth embodiment of a dental tool in accordance with the present invention is substantially the same as the eighth embodiment as shown in FIG. 20 except for the following features. In the ninth embodiment of the present invention, the fixing unit 31G has a fixing hole 311G and an engaging recess 313G. The fixing hole 311G is axially formed in the connecting portion 11G of the body 10G, and the engaging recess 313G is formed at an opening of the fixing hole 311G and is an annular recess that gradually expands from the inside to the outside. The engaging unit 32G has an engaging face 321G and an engaging portion 323G. The engaging face 321G is formed on the external surface of the working element 20G adjacent to the connecting end 21G and is screwed with the fixing hole 311G. The engaging portion 323G is formed on the external surface of the working element 20G away from the connecting end 21G and abuts against the engaging recess 313G. Then the working element 20G is securely connected to the body 10G without shaking. Preferably, with reference to FIG. 22, the engaging unit 32G′ is a hollow tube and has a fixing section 326G′ formed on an external surface of the engaging unit 132G′ at an end of the engaging unit 32G′ and screwed with the fixing hole 311G′. The connecting end 21G′ of the working element 20G′ is inserted into and securely connected to the engaging unit 32G′ by welding (such as laser welding, arc welding, electron beam welding, friction welding, or copper-tin welding), adhesive bonding or negative tolerance interference fit.

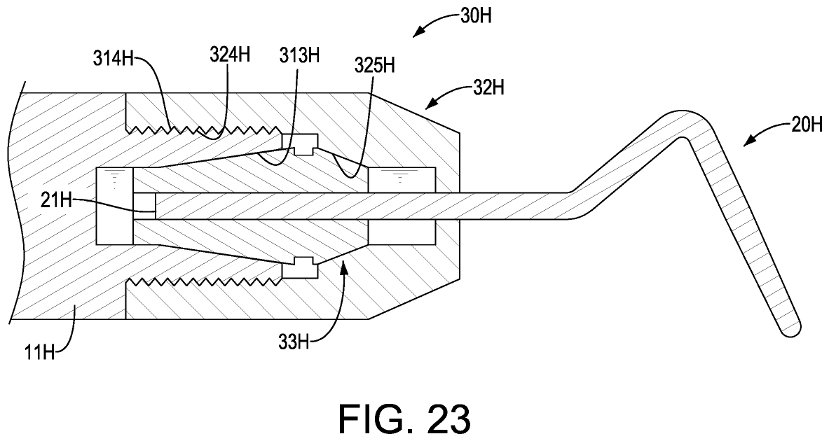

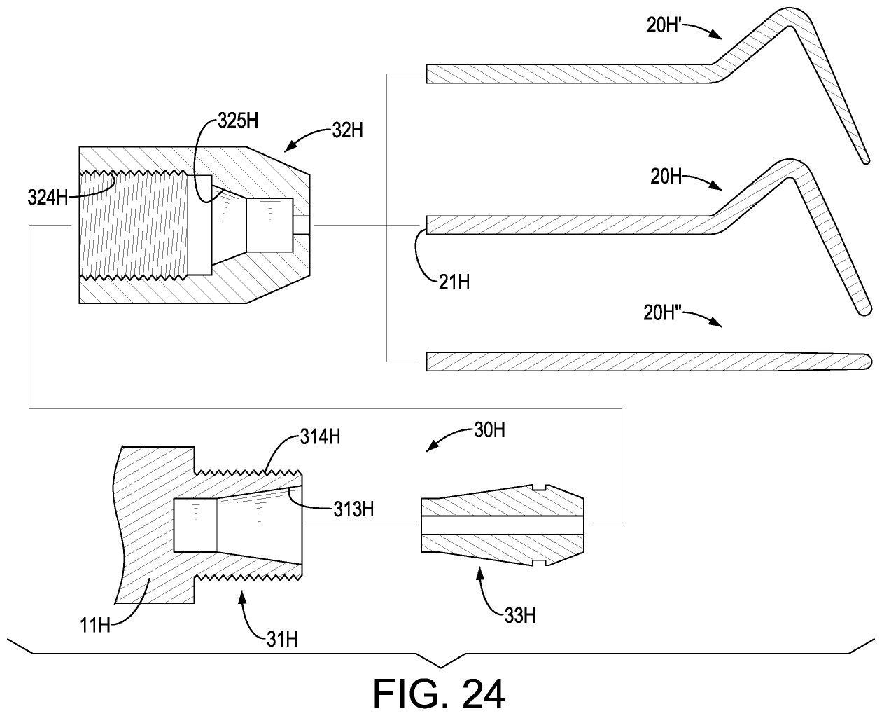

With reference to FIGS. 23 and 24, a tenth embodiment of a dental tool in accordance with the present invention is substantially the same as the sixth embodiment as shown in FIGS. 16 to 18 except for the following features. In the tenth embodiment of the present invention, the fixing unit 31H has a fixing face 314H and an engaging recess 313H, the fixing face 314H is formed on an external surface of the connecting portion 11H, the engaging recess 313H is axially formed in the connecting portion 11H, and the fixing face 314H is disposed around an exterior of the engaging recess 313H. The engaging unit 32H is mounted around the fixing unit 31H and has a fixing recess 324H and a clamping recess 325H. The fixing recess 324H is formed in the engaging unit 32H and is securely connected to the fixing face 314H. The clamping recess 325H is formed in the engaging unit 32H and communicates with the fixing recess 324H.

Furthermore, the fixing mechanism 30H has a pressing unit 33H disposed between the fixing unit 31H and the engaging unit 32H. The pressing unit 33H may be a collet, is disposed in the engaging recess 313H, and abuts against the clamping recess 325H. The connecting end 21H of the working element 20H engages with the pressing unit 33H via the fixing unit 31H and the engaging unit 32H. Preferably, with reference to FIG. 24, according to the arrangement between the fixing unit 31H, the engaging unit 32H, and the pressing unit 33H, different types of working elements 20H, 20H′, 20H″ are securely connected to the fixing mechanism 30H, and this allows users to replace a corresponding working element 20H, 20H′, 20H″ according to the needs.

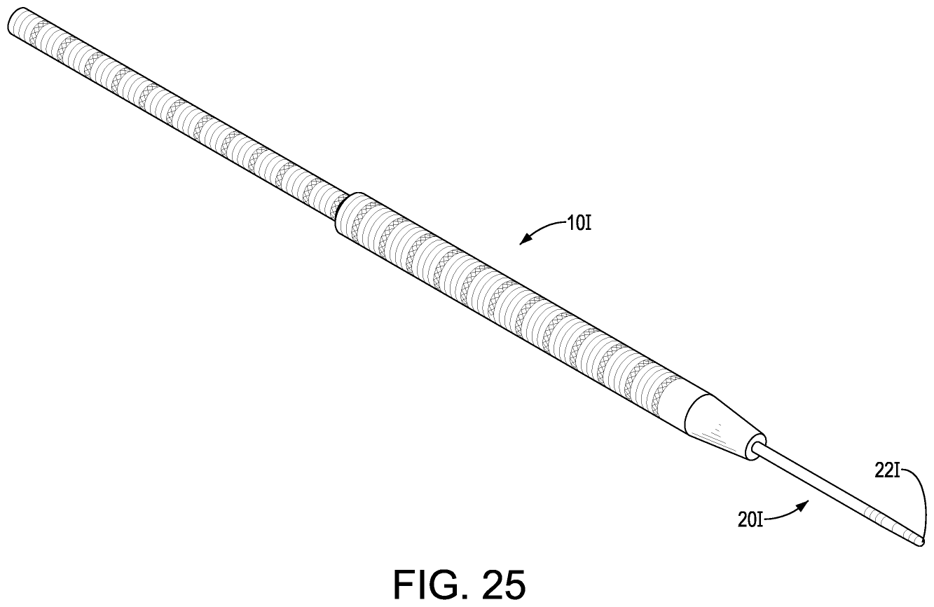

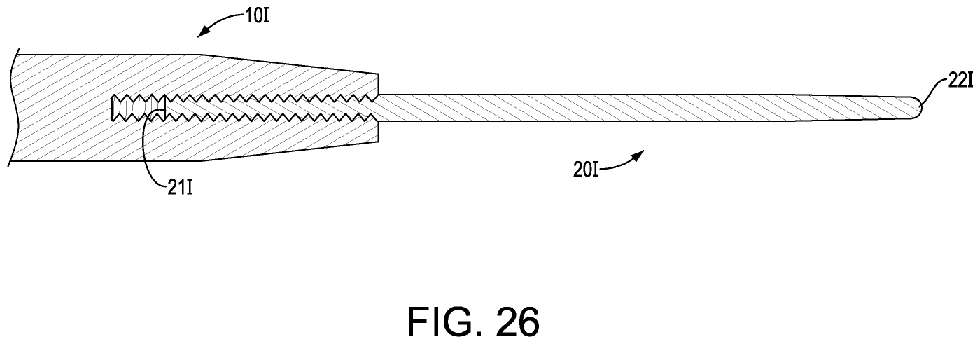

With reference to FIGS. 25 and 26, an eleventh embodiment of a dental tool in accordance with the present invention is substantially the same as the first embodiment as shown in FIGS. 1 to 4 except for the following features. In the eleventh embodiment of the present invention, the working element 20I does not have a curved portion (or the included angle of the curved portion is 0 degree), the connecting end 21I is in a straight line with the working end 22I, and the working element 20I is connected to the body 10I by thread.

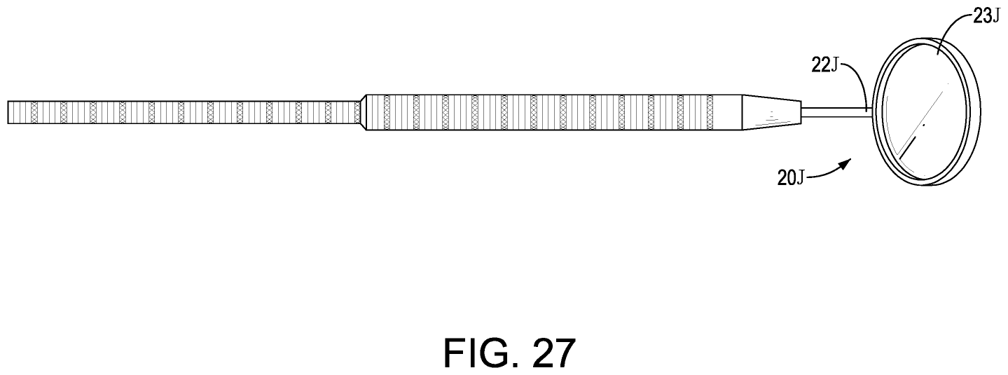

With reference to FIG. 27, a twelfth embodiment of a dental tool in accordance with the present invention is substantially the same as the first embodiment as shown in FIGS. 1 to 4 except for the following features. In the twelfth embodiment of the present invention, the dental tool is a dental mirror, and the working element 20J has a minor 23J disposed on the working end 22J.

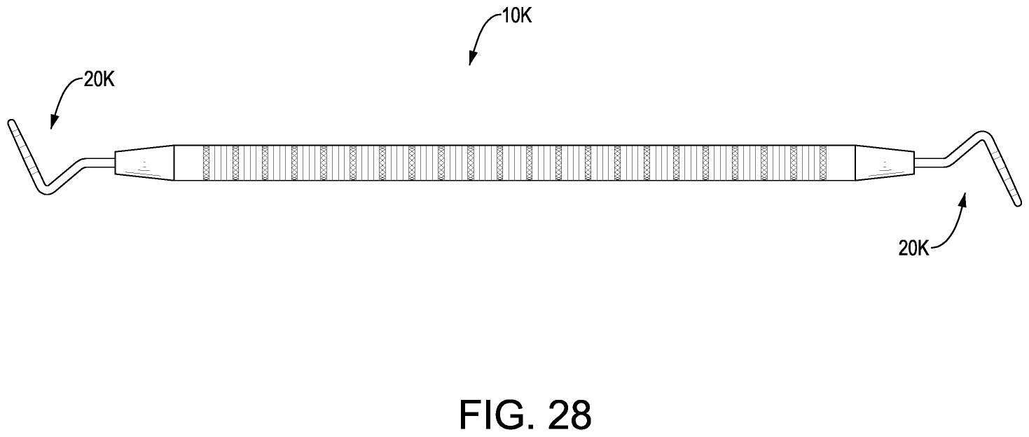

With reference to FIG. 28, a thirteenth embodiment of a dental tool in accordance with the present invention is substantially the same as the fourth embodiment as shown in FIG. 13 except for the following features. In the thirteenth embodiment of the present invention, two working elements 20K are respectively disposed on two ends of the body 10K, and the two working elements 20K can be curved in the same direction or different directions. In addition, each working element 20K may be straight without having a curved portion. Preferably, each working element 20K may be connected to the body 10K by the structures as described in the above-mentioned embodiments and are not to be described in detail.

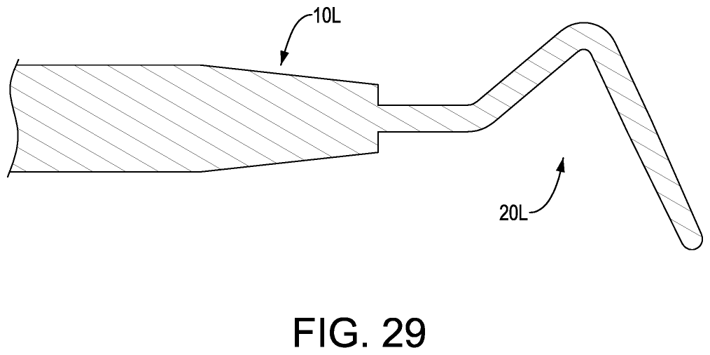

With reference to FIG. 29, a fourteenth embodiment of a dental tool in accordance with the present invention is substantially the same as the first embodiment as shown in FIG. 1 except for the following features. In the fourteenth embodiment of the present invention, the body 10L and the working element 20L are made as a single piece with same material. For example, the dental tool may be made by integrally injection molded through plastic or cast with metal materials. Furthermore, the body 10L may be made of plastic, and the working element 20L may be made of plastic or metal.

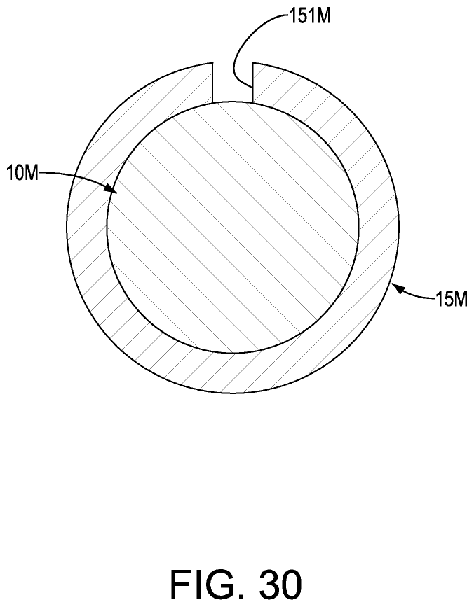

With reference to FIG. 30, a fifteenth embodiment of a dental tool in accordance with the present invention is substantially the same as the third embodiment as shown in FIG. 12 except for the following features. In the fifteenth embodiment of the present invention, the cursor element 15M is a hollow ring, is mounted around the body 10M, and has a gap 151M. A user can measure by pushing the cursor element 15M to move relative to the body 10M.

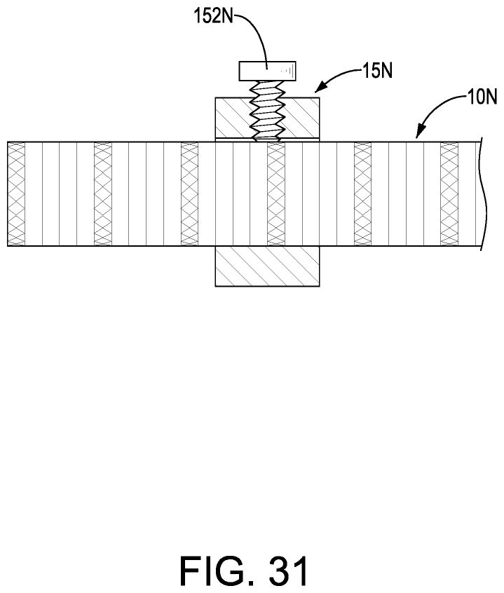

With reference to FIG. 31, a sixteenth embodiment of a dental tool in accordance with the present invention is substantially the same as the third embodiment as shown in FIG. 12 except for the following features. In the sixteenth embodiment of the present invention, the cursor element 15N has a positioning element 152N radially formed through the cursor element 15N to abut against the external surface of the body 10N, and this allows a user to fix the cursor element 15N on a specific location of the body 10N for measurement via the positioning element 152N abutting against the external surface of the body 10N. Preferably, the positioning element 152N is connected to the cursor element 15N by thread.

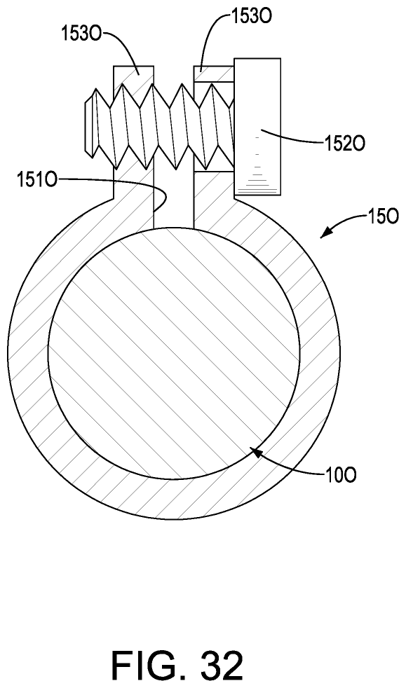

With reference to FIG. 32, a seventeenth embodiment of a dental tool in accordance with the present invention is substantially the same as the fifteenth embodiment as shown in FIG. 30 except for the following features. In the seventeenth embodiment of the present invention, the cursor element 15O has two extending slices 153O respectively formed on and protruded outwardly from two sides of the gap 151O and parallel to each other. The positioning element 152O is transversally extended through one of the two extending slices 153O and is connected to the other one of the two extending slices 153O, and a distance between the two extending slices 153O can be changed by the positioning element 152O to enable the cursor element 15O to press against the body 10O. Then the cursor element 15O can be positioned at a specific location of the body 10O.

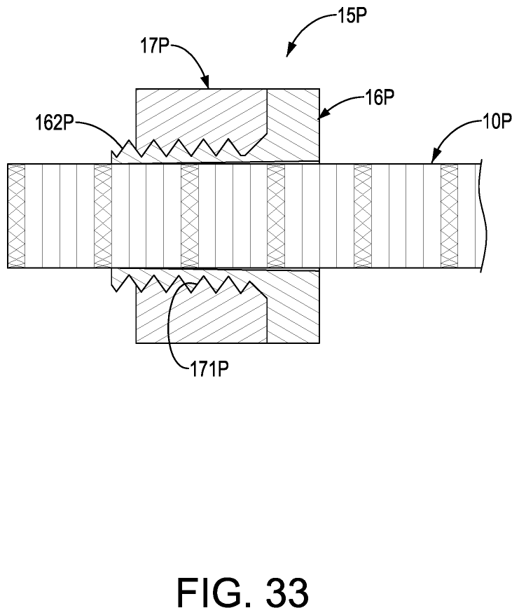

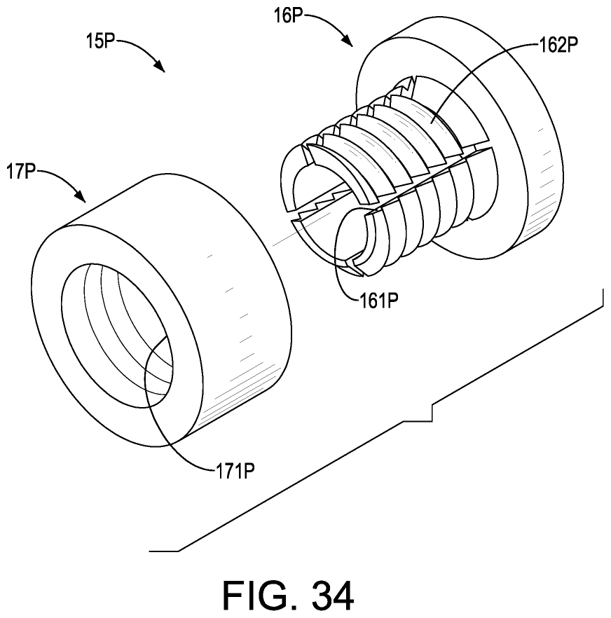

With reference to FIGS. 33 and 34, an eighteenth embodiment of a dental tool in accordance with the present invention is substantially the same as the third embodiment as shown in FIG. 12 except for the following features. In the eighteenth embodiment of the present invention, the cursor element 15P has a pressing sleeve 16P and a threaded tube 17P. The pressing sleeve 16P is movably mounted on the body 10P and has multiple cutting slices 161P and a screwed portion 162P. The cutting slices 161P are axially formed through an external surface of the pressing sleeve 16P at spaced intervals to enable the pressing sleeve 16P to deform to approach or move away from the body 10P. The screwed portion 162P is formed on the external surface of the pressing sleeve 16P. The threaded tube 17P is connected to the pressing sleeve 16P, is disposed on the body 10P, and has a threaded portion 171P formed on an inner surface of the threaded tube 17P and connected to the screwed portion 162P of the pressing sleeve 16P. The size of each one of the cutting slices 161P can be changed by the threaded portion 171P screwed with the screwed portion 162P, and this enables the pressing sleeve 16P to abut against the external surface of the body 10P to locate the cursor element 15P on the body 10P to provide a measuring effect.

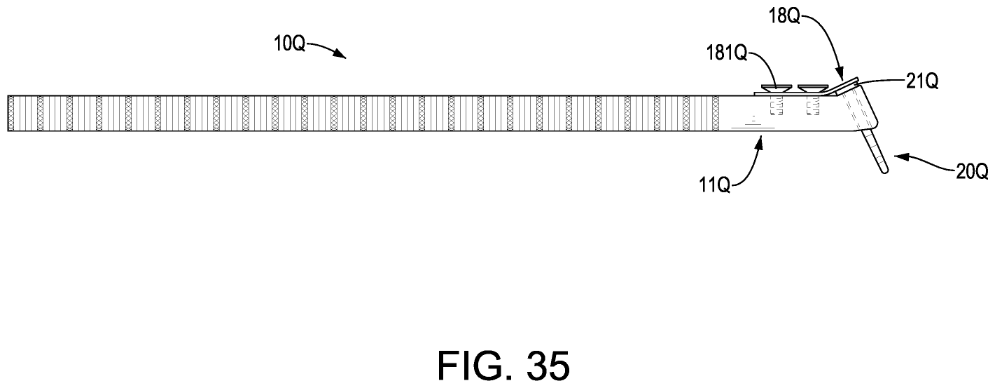

With reference to FIG. 35, a nineteenth embodiment of a dental tool in accordance with the present invention is substantially the same as the fourth embodiment as shown in FIG. 13 except for the following features. In the nineteenth embodiment of the present invention, the body 10Q has a buffering element 18Q, the buffering element 18Q is an elastic sheet, and an end of the buffering element 18Q steadily abuts the external surface of the connecting portion 11Q. The working element 20Q is disposed in the connecting portion 11Q, and the connecting end 21Q of the working element 20Q abuts against another end of the buffering element 18Q to connect the working element 20Q on the connecting portion 11Q of the body 10Q. In addition, the elastic buffering element 18Q can provide the working element 20Q with a buffering effect during use, so as to avoid pain or discomfort to the patient during the detection and treatment process.

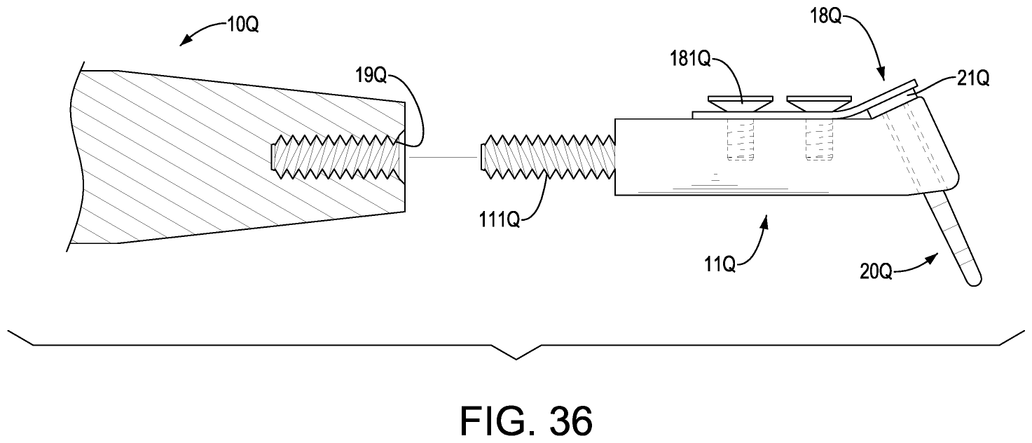

With reference to FIG. 36, a twentieth embodiment of a dental tool in accordance with the present invention is substantially the same as the nineteenth embodiment as shown in FIG. 35 except for the following features. In the twentieth embodiment of the present invention, the connecting portion 11Q is detachably connected to the body 10Q and has a connecting rod 111Q formed on and protruded from an end of the connecting portion 11Q away from the working element 20Q. The connecting rod 111Q has a thread formed on an external surface thereof, and the body 10Q has a connecting recess 19Q connected to the connecting rod 111Q. Then the connecting portion 11Q can be detachably connected to the body 10Q.

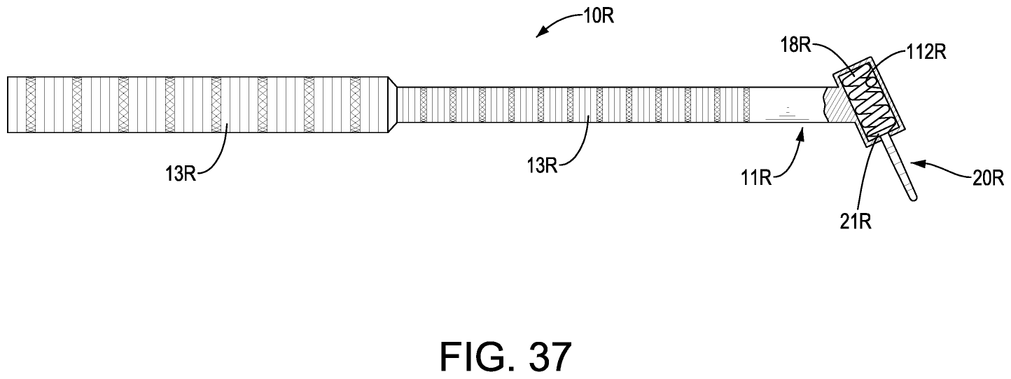

With reference to FIG. 37, a twenty-first embodiment of a dental tool in accordance with the present invention is substantially the same as the nineteenth embodiment as shown in FIG. 35 except for the following features. In the twenty-first embodiment of the present invention, the two rod portions 13R of the body 10R have different outer diameters, the connecting portion 11R has a hollow chamber 112R, and the buffering element 18R is mounted in the chamber 112R and is a spring. The connecting end 21R of the working element 20R is mounted in the chamber 112R and abuts against the buffering element 18R. The working element 20R can move relative to the connecting portion 11R and extend into the chamber 112R during use via the elastic buffering of the buffering element 18R. Then the dental tool can provide a buffering effect.

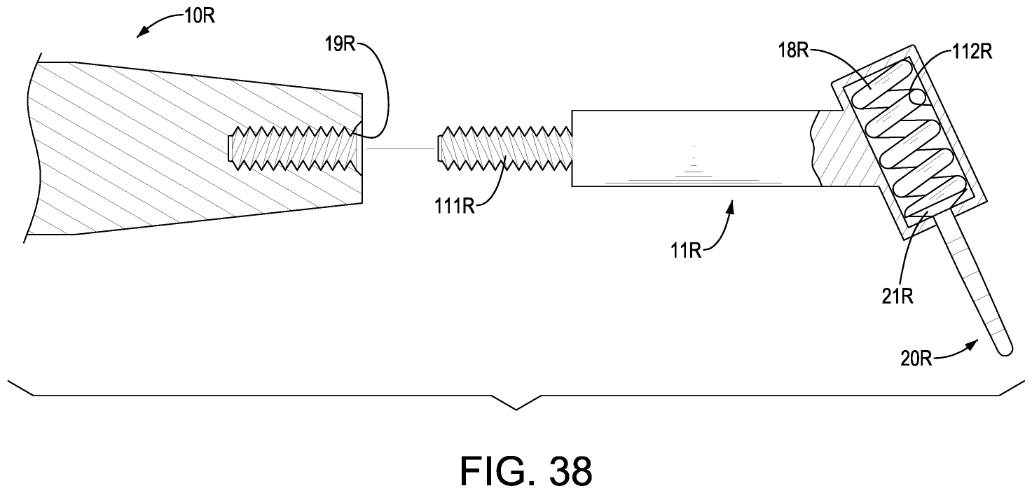

With reference to FIG. 38, a twenty-second embodiment of a dental tool in accordance with the present invention is substantially the same as the twenty-first embodiment as shown in FIG. 37 except for the following features. In the twenty-second embodiment of the present invention, the connecting portion 11R is detachably connected to the body 10R and has a connecting rod 111R formed on and protruded from an end of the connecting portion 11R away from the working element 20R. The connecting rod 111R has a thread formed on an external surface thereof, and the body 10R has a connecting recess 19R connected to the connecting rod 111R. Then the connecting portion 11R can be detachably connected to the body 10R.

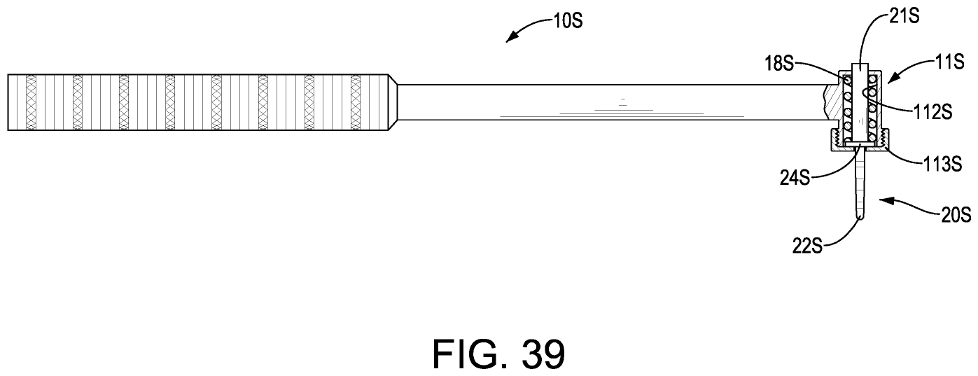

With reference to FIG. 39, a twenty-third embodiment of a dental tool in accordance with the present invention is substantially the same as the twenty-first embodiment as shown in FIG. 37 except for the following features. In the twenty-second embodiment of the present invention, the connecting portion 115 of the body 10S has a cover 113S disposed below the chamber 112S, and the buffering element 18S is mounted in the chamber 112S and is a spring. The working element 20S has an annular flange 24S formed between the connecting end 21S and the working end 22S and disposed in the chamber 112S. The annular flange 24S abuts the cover 113S and the buffering element 18S. The working element 20S can be moved in the chamber 112S relative to the connecting portion 11S via the buffering element 18S abutting the annular flange 24S, and this enables the dental tool to provide a buffering effect.

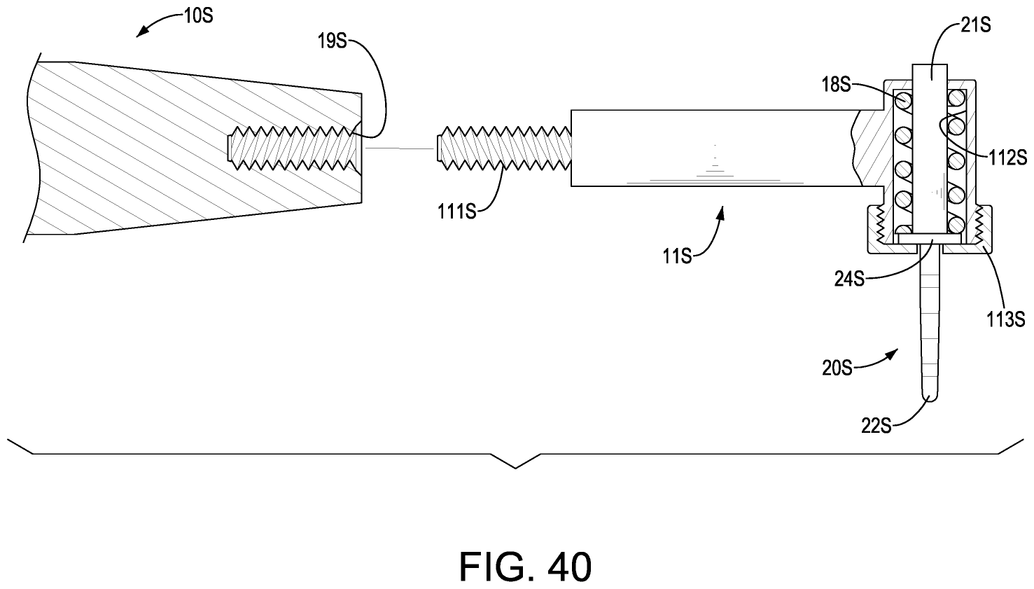

With reference to FIG. 40, a twenty-fourth embodiment of a dental tool in accordance with the present invention is substantially the same as the twenty-third embodiment as shown in FIG. 39 except for the following features. In the twenty-fourth embodiment of the present invention, the connecting portion 11S is detachably connected to the body 10S and has a connecting rod 111S formed on and protruded from an end of the connecting portion 11S away from the working element 205. The connecting rod 111S has a thread formed on an external surface thereof, and the body 10S has a connecting recess 19S connected to the connecting rod 111S. Then the connecting portion 11S can be detachably connected to the body 10S.

In the above-mentioned embodiments of the present invention, the fixing mechanism 30D, 30H is disposed between the body 10, 10B, 10D, 10E, 10G, 10I, 10K, 10M, 10N, 100, 10P, 10Q, 10R, 10S and the working element 20, 20D, 20E, 20G, 20G′, 20H, 20I, 20J, 20K, 20L, 20Q, 20R, 20S, and this allows users to replace the working element 20, 20D, 20E, 20G, 20G′, 20H, 20I, 20J, 20K, 20L, 20Q, 20R, 20S with different sizes, structural strength, elasticity or shapes according to the users' needs to improve the practicability and applicability of the dental tool of the present invention.

According to the above-mentioned features and structural relationships of the dental tool of the present invention, the dental tool of the present invention can provide a detection effect via the working element 20, 20D, 20E, 20G, 20G′, 20H, 20I, 20J, 20K, 20L, 20Q, 20R, 20S, and can use the working element 20, 20D, 20E, 20G, 20G, 20G′, 20H, 20H′, 20H″, 20I, 20J, 20K, 20L, 20Q, 20R, 20S that is made of shape memory alloy, stainless steel, titanium alloy, platinum or tungsten to effectively avoid excessive force making patients feel uncomfortable during diagnosis. When the dental tool falls to the ground or collides with other objects, the working ends 22, 22I, 22J, 22S of the working element 20, 20D, 20E, 20F, 20G, 20G, 20G′, 20H, 20H′, 20H″, 20I, 20J, 20K, 20L, 20Q, 20R, 20S can respond to external forces and return to the original state after elastic bending or deformation without affecting the situation of subsequent reuse.

Furthermore, the working element 20, 20D, 20E, 20F, 20G, 20G′, 20H, 20H′, 20H″, 20I, 20J, 20K, 20L, 20Q, 20R, 20S with super-elastic physical properties can avoid puncturing the sinus membrane and the related problems that follow. In addition, the measuring portion 12, 12C disposed on the body 10, 10B, 10D, 10E, 10G, 10I, 10K, 10M, 10N, 100, 10P, 10Q, 10R, 10S allows the dental tool of the present invention to measure and locate relative positions of the teeth 50 in the patient's mouth, so as to accurately perform subsequent drilling or implantation of dental implants 80. This operation can improve the surgical quality of dental implants, and can replace the use of conventional surgical guides to provide a convenient use and cost-saving effect.

Additionally, the body 10L and the work piece 20L can be made of plastic or metal and can be made as a single piece. Furthermore, the fixing mechanism 30D, 30H is disposed between the body 10, 10B, 10D, 10E, 10G, 10I, 10K, 10L, 10M, 10N, 100, 10P, 10Q, 10R, 10S and the working element 20, 20D, 20E, 20F, 20G, 20G′, 20H, 20H′, 20H″, 20I, 20J, 20K, 20L, 20Q, 20R, 20S, and this allows users to replace working elements 20, 20D, 20E, 20F, 20G, 20G′, 20H, 20H′, 20H″, 20I, 20J, 20K, 20L, 20Q, 20R, 20S with different sizes, materials, structural strength, elasticity or shapes according to the users' needs. Then the practicability and applicability of the dental tool of the present invention can be improved, thereby providing a dental tool with measurement effect, improved detection experience, and convenient use.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A dental tool comprising:
a body having
a connecting portion disposed on an end of the body; and
a measuring portion formed on an external surface of the body opposite to the connecting portion;
a working element connected to the body and having
a connecting end connected to the connecting portion of the body; and
a working end connected to the connecting end of the working element and extended out of the connecting portion of the body.

2. The dental tool as claimed in claim 1, wherein the measuring portion has
a graduated scale formed on the external surface of the body every 1 millimeter; and
a mark formed on the external surface of the body every 5 millimeters.

3. The dental tool as claimed in claim 2, wherein a number mark is formed on the external surface of the body at each mark of the measuring portion.

4. The dental tool as claimed in claim 2, wherein each mark of the measuring portion is a mesh notch or an obvious trace notch.

5. The dental tool as claimed in claim 2, wherein each mark of the measuring portion is a bold notch.

6. The dental tool as claimed in claim 1, wherein the working element is a rod made of shape memory alloys.

7. The dental tool as claimed in claim 2, wherein the working element is a rod made of shape memory alloys.

8. The dental tool as claimed in claim 3, wherein the working element is a rod made of shape memory alloys.

9. The dental tool as claimed in claim 4, wherein the working element is a rod made of shape memory alloys.

10. The dental tool as claimed in claim 5, wherein the working element is a rod made of shape memory alloys.

11. The dental tool as claimed in claim 6, wherein
the dental tool has a fixing mechanism disposed between the body and the working element; and
the fixing mechanism has
a fixing unit disposed on the connecting portion and having
a fixing hole radially formed in the connecting portion and communicating with an interior of the connecting portion; and
a fixing element connected to the fixing hole and extended into the interior of the connecting portion; and
an engaging unit disposed on the working element adjacent to the connecting end and having at least one engaging face formed on an external surface of the working element, extended into the interior of the connecting portion via the connecting end, and aligning with the fixing hole;
wherein the fixing element engages with the at least one engaging face via the fixing hole to connect the working element securely to the body.

12. The dental tool as claimed in claim 7, wherein
the dental tool has a fixing mechanism disposed between the body and the working element; and
the fixing mechanism has
a fixing unit disposed on the connecting portion and having
a fixing hole radially formed in the connecting portion and communicating with an interior of the connecting portion; and
a fixing element connected to the fixing hole and extended into the interior of the connecting portion; and
an engaging unit disposed on the working element adjacent to the connecting end and having at least one engaging face formed on an external surface of the working element, extended into the interior of the connecting portion via the connecting end, and aligning with the fixing hole;
wherein the fixing element engages with the at least one engaging face via the fixing hole to connect the working element securely to the body.

13. The dental tool as claimed in claim 8, wherein
the dental tool has a fixing mechanism disposed between the body and the working element; and
the fixing mechanism has
a fixing unit disposed on the connecting portion and having
a fixing hole radially formed in the connecting portion and communicating with an interior of the connecting portion; and
a fixing element connected to the fixing hole and extended into the interior of the connecting portion; and
an engaging unit disposed on the working element adjacent to the connecting end and having at least one engaging face formed on an external surface of the working element, extended into the interior of the connecting portion via the connecting end, and aligning with the fixing hole;
wherein the fixing element engages with the at least one engaging face via the fixing hole to connect the working element securely to the body.

14. The dental tool as claimed in claim 9, wherein
the dental tool has a fixing mechanism disposed between the body and the working element; and
the fixing mechanism has
a fixing unit disposed on the connecting portion and having
a fixing hole radially formed in the connecting portion and communicating with an interior of the connecting portion; and
a fixing element connected to the fixing hole and extended into the interior of the connecting portion; and
an engaging unit disposed on the working element adjacent to the connecting end and having at least one engaging face formed on an external surface of the working element, extended into the interior of the connecting portion via the connecting end, and aligning with the fixing hole;
wherein the fixing element engages with the at least one engaging face via the fixing hole to connect the working element securely to the body.

15. The dental tool as claimed in claim 10, wherein
the dental tool has a fixing mechanism disposed between the body and the working element; and
the fixing mechanism has
a fixing unit disposed on the connecting portion and having
a fixing hole radially formed in the connecting portion and communicating with an interior of the connecting portion; and
a fixing element connected to the fixing hole and extended into the interior of the connecting portion; and
an engaging unit disposed on the working element adjacent to the connecting end and having at least one engaging face formed on an external surface of the working element, extended into the interior of the connecting portion via the connecting end, and aligning with the fixing hole;
wherein the fixing element engages with the at least one engaging face via the fixing hole to connect the working element securely to the body.

16. The dental tool as claimed in claim 11, wherein the engaging unit has two engaging faces parallelly formed on the external surface of the working element, and the fixing element engages with one of the two engaging faces.

17. The dental tool as claimed in claim 12, wherein the engaging unit has two engaging faces parallelly formed on the external surface of the working element, and the fixing element engages with one of the two engaging faces.

18. The dental tool as claimed in claim 13, wherein the engaging unit has two engaging faces parallelly formed on the external surface of the working element, and the fixing element engages with one of the two engaging faces.

19. The dental tool as claimed in claim 14, wherein the engaging unit has two engaging faces parallelly formed on the external surface of the working element, and the fixing element engages with one of the two engaging faces.

20. The dental tool as claimed in claim 15, wherein the engaging unit has two engaging faces parallelly formed on the external surface of the working element, and the fixing element engages with one of the two engaging faces.

21. The dental tool as claimed in claim 6, wherein
the dental tool has a fixing mechanism disposed between the body and the working element; and
the fixing mechanism has
a fixing unit disposed on the connecting portion and having
a fixing hole radially formed in the connecting portion and communicating with an interior of the connecting portion; and
a fixing element connected to the fixing hole and extended into the interior of the connecting portion; and
an engaging unit disposed on the working element adjacent to the connecting end and having an engaging annular face formed on an external surface of the working element adjacent to the working end;
wherein the fixing element of the fixing unit engages with the engaging annular face to connect the working element securely to the body.

22. The dental tool as claimed in claim 7, wherein
the dental tool has a fixing mechanism disposed between the body and the working element; and
the fixing mechanism has
a fixing unit disposed on the connecting portion and having
a fixing hole radially formed in the connecting portion and communicating with an interior of the connecting portion; and
a fixing element connected to the fixing hole and extended into the interior of the connecting portion; and
an engaging unit disposed on the working element adjacent to the connecting end and having an engaging annular face formed on an external surface of the working element adjacent to the working end;
wherein the fixing element of the fixing unit engages with the engaging annular face to connect the working element securely to the body.

23. The dental tool as claimed in claim 8, wherein
the dental tool has a fixing mechanism disposed between the body and the working element; and
the fixing mechanism has
a fixing unit disposed on the connecting portion and having
a fixing hole radially formed in the connecting portion and communicating with an interior of the connecting portion; and
a fixing element connected to the fixing hole and extended into the interior of the connecting portion; and
an engaging unit disposed on the working element adjacent to the connecting end and having an engaging annular face formed on an external surface of the working element adjacent to the working end;
wherein the fixing element of the fixing unit engages with the engaging annular face to connect the working element securely to the body.

24. The dental tool as claimed in claim 9, wherein
the dental tool has a fixing mechanism disposed between the body and the working element; and
the fixing mechanism has
a fixing unit disposed on the connecting portion and having
a fixing hole radially formed in the connecting portion and communicating with an interior of the connecting portion; and
a fixing element connected to the fixing hole and extended into the interior of the connecting portion; and
an engaging unit disposed on the working element adjacent to the connecting end and having an engaging annular face formed on an external surface of the working element adjacent to the working end;
wherein the fixing element of the fixing unit engages with the engaging annular face to connect the working element securely to the body.

25. The dental tool as claimed in claim 10, wherein
the dental tool has a fixing mechanism disposed between the body and the working element; and
the fixing mechanism has
fixing unit disposed on the connecting portion and having
a fixing hole radially formed in the connecting portion and communicating with an interior of the connecting portion; and
a fixing element connected to the fixing hole and extended into the interior of the connecting portion; and
an engaging unit disposed on the working element adjacent to the connecting end and having an engaging annular face formed on an external surface of the working element adjacent to the working end;
wherein the fixing element of the fixing unit engages with the engaging annular face to connect the working element securely to the body.

26. The dental tool as claimed in claim 6, wherein
the dental tool has a fixing mechanism disposed between the body and the working element; and
the fixing mechanism has
a fixing unit having a fixing hole axially formed in the connecting portion and being a tapered groove that gradually expands from the inside to the outside;
an engaging unit disposed on the external surface of the working element adjacent to the connecting end and having a tapered engaging annular face engaged with the fixing hole;
wherein the tapered engaging annular face is securely connected to the fixing hole by welding, interference combination of thermal expansion and cold contraction, coating of adhesives or negative tolerance interference fit.

27. The dental tool as claimed in claim 7, wherein
the dental tool has a fixing mechanism disposed between the body and the working element; and
the fixing mechanism has
a fixing unit having a fixing hole axially formed in the connecting portion and being a tapered groove that gradually expands from the inside to the outside;
an engaging unit disposed on the external surface of the working element adjacent to the connecting end and having a tapered engaging annular face engaged with the fixing hole;
wherein the tapered engaging annular face is securely connected to the fixing hole by welding, interference combination of thermal expansion and cold contraction, coating of adhesives or negative tolerance interference fit.

28. The dental tool as claimed in claim 8, wherein
the dental tool has a fixing mechanism disposed between the body and the working element; and
the fixing mechanism has
a fixing unit having a fixing hole axially formed in the connecting portion and being a tapered groove that gradually expands from the inside to the outside;
an engaging unit disposed on the external surface of the working element adjacent to the connecting end and having a tapered engaging annular face engaged with the fixing hole;
wherein the tapered engaging annular face is securely connected to the fixing hole by welding, interference combination of thermal expansion and cold contraction, coating of adhesives or negative tolerance interference fit.

29. The dental tool as claimed in claim 9, wherein
the dental tool has a fixing mechanism disposed between the body and the working element; and
the fixing mechanism has
a fixing unit having a fixing hole axially formed in the connecting portion and being a tapered groove that gradually expands from the inside to the outside;
an engaging unit disposed on the external surface of the working element adjacent to the connecting end and having a tapered engaging annular face engaged with the fixing hole;
wherein the tapered engaging annular face is securely connected to the fixing hole by welding, interference combination of thermal expansion and cold contraction, coating of adhesives or negative tolerance interference fit.

30. The dental tool as claimed in claim 10, wherein
the dental tool has a fixing mechanism disposed between the body and the working element; and
the fixing mechanism has
a fixing unit having a fixing hole axially formed in the connecting portion and being a tapered groove that gradually expands from the inside to the outside;
an engaging unit disposed on the external surface of the working element adjacent to the connecting end and having a tapered engaging annular face engaged with the fixing hole;
wherein the tapered engaging annular face is securely connected to the fixing hole by welding, interference combination of thermal expansion and cold contraction, coating of adhesives or negative tolerance interference fit.

31. The dental tool as claimed in claim 6, wherein
the dental tool has a fixing mechanism disposed between the body and the working element; and
the fixing mechanism has
a fixing unit having
a fixing hole axially formed in the connecting portion of the body; and
an engaging recess formed at an opening of the fixing hole and being an annular recess that gradually expands from the inside to the outside; and
an engaging unit having
an engaging face formed on the external surface of the working element adjacent to the connecting end and screwed with the fixing hole; and
an engaging portion formed on the external surface of the working element away from the connecting end and abutted against the engaging recess;
wherein the working element is securely connected to the body without shaking.

32. The dental tool as claimed in claim 7, wherein
the dental tool has a fixing mechanism disposed between the body and the working element; and
the fixing mechanism has
a fixing unit having
a fixing hole axially formed in the connecting portion of the body; and
an engaging recess formed at an opening of the fixing hole and being an annular recess that gradually expands from the inside to the outside; and
an engaging unit having
an engaging face formed on the external surface of the working element adjacent to the connecting end and screwed with the fixing hole; and
an engaging portion formed on the external surface of the working element away from the connecting end and abutted against the engaging recess;
wherein the working element is securely connected to the body without shaking.

33. The dental tool as claimed in claim 8, wherein
the dental tool has a fixing mechanism disposed between the body and the working element; and
the fixing mechanism has
a fixing unit having
a fixing hole axially formed in the connecting portion of the body; and
an engaging recess formed at an opening of the fixing hole and being an annular recess that gradually expands from the inside to the outside; and
an engaging unit having
an engaging face formed on the external surface of the working element adjacent to the connecting end and screwed with the fixing hole; and
an engaging portion formed on the external surface of the working element away from the connecting end and abutted against the engaging recess;
wherein the working element is securely connected to the body without shaking.

34. The dental tool as claimed in claim 9, wherein
the dental tool has a fixing mechanism disposed between the body and the working element; and
the fixing mechanism has
a fixing unit having
a fixing hole axially formed in the connecting portion of the body; and
an engaging recess formed at an opening of the fixing hole and being an annular recess that gradually expands from the inside to the outside; and
an engaging unit having
an engaging face formed on the external surface of the working element adjacent to the connecting end and screwed with the fixing hole; and
an engaging portion formed on the external surface of the working element away from the connecting end and abutted against the engaging recess;
wherein the working element is securely connected to the body without shaking.

35. The dental tool as claimed in claim 10, wherein
the dental tool has a fixing mechanism disposed between the body and the working element; and
the fixing mechanism has
a fixing unit having
a fixing hole axially formed in the connecting portion of the body; and
an engaging recess formed at an opening of the fixing hole and being an annular recess that gradually expands from the inside to the outside; and
an engaging unit having
an engaging face formed on the external surface of the working element adjacent to the connecting end and screwed with the fixing hole; and
an engaging portion formed on the external surface of the working element away from the connecting end and abutted against the engaging recess;
wherein the working element is securely connected to the body without shaking.

36. The dental tool as claimed in claim 6, wherein
the dental tool has a fixing mechanism disposed between the body and the working element;
the fixing mechanism has
a fixing unit having a fixing hole axially formed in the connecting portion of the body; and
an engaging unit being a hollow tube and having a fixing section formed on an external surface of the engaging unit at an end of the engaging unit and screwed with the fixing hole; and
the connecting end of the working element is inserted into and securely connected to the engaging unit.

37. The dental tool as claimed in claim 7, wherein
the dental tool has a fixing mechanism disposed between the body and the working element;
the fixing mechanism has
a fixing unit having a fixing hole axially formed in the connecting portion of the body; and
an engaging unit being a hollow tube and having a fixing section formed on an external surface of the engaging unit at an end of the engaging unit and screwed with the fixing hole; and
the connecting end of the working element is inserted into and securely connected to the engaging unit.

38. The dental tool as claimed in claim 8, wherein
the dental tool has a fixing mechanism disposed between the body and the working element;
the fixing mechanism has
a fixing unit having a fixing hole axially formed in the connecting portion of the body; and
an engaging unit being a hollow tube and having a fixing section formed on an external surface of the engaging unit at an end of the engaging unit and screwed with the fixing hole; and
the connecting end of the working element is inserted into and securely connected to the engaging unit.

39. The dental tool as claimed in claim 9, wherein
the dental tool has a fixing mechanism disposed between the body and the working element;
the fixing mechanism has
a fixing unit having a fixing hole axially formed in the connecting portion of the body; and
an engaging unit being a hollow tube and having a fixing section formed on an external surface of the engaging unit at an end of the engaging unit and screwed with the fixing hole; and
the connecting end of the working element is inserted into and securely connected to the engaging unit.

40. The dental tool as claimed in claim 10, wherein
the dental tool has a fixing mechanism disposed between the body and the working element;
the fixing mechanism has
a fixing unit having a fixing hole axially formed in the connecting portion of the body; and
an engaging unit being a hollow tube and having a fixing section formed on an external surface of the engaging unit at an end of the engaging unit and screwed with the fixing hole; and
the connecting end of the working element is inserted into and securely connected to the engaging unit.

41. The dental tool as claimed in claim 6, wherein
the dental tool has a fixing mechanism disposed between the body and the working element;
the fixing mechanism has
a fixing unit having
a fixing face formed on an external surface of the connecting portion; and
an engaging recess axially formed in the connecting portion;
wherein the fixing face is disposed around an exterior of the engaging recess;
an engaging unit mounted around the fixing unit and having
a fixing recess formed in the engaging unit and securely connected to the fixing face; and
a clamping recess formed in the engaging unit and communicating with the fixing recess; and
a pressing unit disposed in the engaging recess and abutted against the clamping recess; and
the connecting end of the working element engages with the pressing unit via the fixing unit and the engaging unit.

42. The dental tool as claimed in claim 7, wherein
the dental tool has a fixing mechanism disposed between the body and the working element;
the fixing mechanism has
a fixing unit having
a fixing face formed on an external surface of the connecting portion; and
an engaging recess axially formed in the connecting portion;
wherein the fixing face is disposed around an exterior of the engaging recess;
an engaging unit mounted around the fixing unit and having
a fixing recess formed in the engaging unit and securely connected to the fixing face; and
a clamping recess formed in the engaging unit and communicating with the fixing recess; and
a pressing unit disposed in the engaging recess and abutted against the clamping recess; and
the connecting end of the working element engages with the pressing unit via the fixing unit and the engaging unit.

43. The dental tool as claimed in claim 8, wherein
the dental tool has a fixing mechanism disposed between the body and the working element;
the fixing mechanism has
a fixing unit having
a fixing face formed on an external surface of the connecting portion; and
an engaging recess axially formed in the connecting portion;
wherein the fixing face is disposed around an exterior of the engaging recess;
an engaging unit mounted around the fixing unit and having
a fixing recess formed in the engaging unit and securely connected to the fixing face; and
a clamping recess formed in the engaging unit and communicating with the fixing recess; and
pressing unit disposed in the engaging recess and abutted against the clamping recess; and
the connecting end of the working element engages with the pressing unit via the fixing unit and the engaging unit.

44. The dental tool as claimed in claim 9, wherein
the dental tool has a fixing mechanism disposed between the body and the working element;
the fixing mechanism has
a fixing unit having
a fixing face formed on an external surface of the connecting portion; and
an engaging recess axially formed in the connecting portion;
wherein the fixing face is disposed around an exterior of the engaging recess;
an engaging unit mounted around the fixing unit and having
a fixing recess formed in the engaging unit and securely connected to the fixing face; and
clamping recess formed in the engaging unit and communicating with the fixing recess; and
a pressing unit disposed in the engaging recess and abutted against the clamping recess; and
the connecting end of the working element engages with the pressing unit via the fixing unit and the engaging unit.

45. The dental tool as claimed in claim 10, wherein
the dental tool has a fixing mechanism disposed between the body and the working element;
the fixing mechanism has
a fixing unit having
a fixing face formed on an external surface of the connecting portion; and
an engaging recess axially formed in the connecting portion;
wherein the fixing face is disposed around an exterior of the engaging recess;
an engaging unit mounted around the fixing unit and having
a fixing recess formed in the engaging unit and securely connected to the fixing face; and
a clamping recess formed in the engaging unit and communicating with the fixing recess; and
a pressing unit disposed in the engaging recess and abutted against the clamping recess; and
the connecting end of the working element engages with the pressing unit via the fixing unit and the engaging unit.

46. The dental tool as claimed in claim 1, wherein the dental tool is an explorer.

47. The dental tool as claimed in claim 2, wherein the dental tool is an explorer.

48. The dental tool as claimed in claim 3, wherein the dental tool is an explorer.

49. The dental tool as claimed in claim 4, wherein the dental tool is an explorer.

50. The dental tool as claimed in claim 5, wherein the dental tool is an explorer.

51. The dental tool as claimed in claim 1, wherein the dental tool is a dental mirror, and the working element has a minor disposed on the working end.

52. The dental tool as claimed in claim 2, wherein the dental tool is a dental mirror, and the working element has a minor disposed on the working end.

53. The dental tool as claimed in claim 3, wherein the dental tool is a dental mirror, and the working element has a minor disposed on the working end.

54. The dental tool as claimed in claim 4, wherein the dental tool is a dental mirror, and the working element has a minor disposed on the working end.

55. The dental tool as claimed in claim 5, wherein the dental tool is a dental mirror, and the working element has a minor disposed on the working end.

56. The dental tool as claimed in claim 2, wherein the body has a cursor element movably mounted around the body and aligning with one of the graduated scales or the marks of the measuring portion.

57. The dental tool as claimed in claim 3, wherein the body has a cursor element movably mounted around the body and aligning with one of the graduated scales or the marks of the measuring portion.

58. The dental tool as claimed in claim 4, wherein the body has a cursor element movably mounted around the body and aligning with one of the graduated scales or the marks of the measuring portion.

59. The dental tool as claimed in claim 5, wherein the body has a cursor element movably mounted around the body and aligning with one of the graduated scales or the marks of the measuring portion.

60. The dental tool as claimed in claim 56, wherein the cursor element is a tube mounted around the body.

61. The dental tool as claimed in claim 57, wherein the cursor element is a tube mounted around the body.

62. The dental tool as claimed in claim 58, wherein the cursor element is a tube mounted around the body.

63. The dental tool as claimed in claim 59, wherein the cursor element is a tube mounted around the body.

64. The dental tool as claimed in claim 56, wherein the cursor element is a hollow ring, is mounted around the body, and has a gap.

65. The dental tool as claimed in claim 57, wherein the cursor element is a hollow ring, is mounted around the body, and has a gap.

66. The dental tool as claimed in claim 58, wherein the cursor element is a hollow ring, is mounted around the body, and has a gap.

67. The dental tool as claimed in claim 59, wherein the cursor element is a hollow ring, is mounted around the body, and has a gap.

68. The dental tool as claimed in claim 56, wherein the cursor element has a positioning element radially formed through the cursor element to abut against the external surface of the body.

69. The dental tool as claimed in claim 57, wherein the cursor element has a positioning element radially formed through the cursor element to abut against the external surface of the body.

70. The dental tool as claimed in claim 58, wherein the cursor element has a positioning element radially formed through the cursor element to abut against the external surface of the body.

71. The dental tool as claimed in claim 59, wherein the cursor element has a positioning element radially formed through the cursor element to abut against the external surface of the body.

72. The dental tool as claimed in claim 64, wherein the cursor element has
two extending slices respectively formed on and protruded outwardly from two sides of the gap and parallel to each other; and
a positioning element transversally extended through one of the two extending slices and connected to the other one of the two extending slices.

73. The dental tool as claimed in claim 65, wherein the cursor element has
two extending slices respectively formed on and protruded outwardly from two sides of the gap and parallel to each other; and
positioning element transversally extended through one of the two extending slices and connected to the other one of the two extending slices.

74. The dental tool as claimed in claim 66, wherein the cursor element has
two extending slices respectively formed on and protruded outwardly from two sides of the gap and parallel to each other; and
positioning element transversally extended through one of the two extending slices and connected to the other one of the two extending slices.

75. The dental tool as claimed in claim 67, wherein the cursor element has
two extending slices respectively formed on and protruded outwardly from two sides of the gap and parallel to each other; and
a positioning element transversally extended through one of the two extending slices and connected to the other one of the two extending slices.

76. The dental tool as claimed in claim 56, wherein the cursor element has
a pressing sleeve movably mounted on the body and having
multiple cutting slices axially formed through an external surface of the pressing sleeve at spaced intervals; and
a screwed portion formed on the external surface of the pressing sleeve; and
a threaded tube connected to the pressing sleeve, disposed on the body, and having a threaded portion formed on an inner surface of the threaded tube and connected to the screwed portion of the pressing sleeve.

77. The dental tool as claimed in claim 57, wherein the cursor element has
a pressing sleeve movably mounted on the body and having
multiple cutting slices axially formed through an external surface of the pressing sleeve at spaced intervals; and
a screwed portion formed on the external surface of the pressing sleeve; and
threaded tube connected to the pressing sleeve, disposed on the body, and having a threaded portion formed on an inner surface of the threaded tube and connected to the screwed portion of the pressing sleeve.

78. The dental tool as claimed in claim 58, wherein the cursor element has
a pressing sleeve movably mounted on the body and having
multiple cutting slices axially formed through an external surface of the pressing sleeve at spaced intervals; and
a screwed portion formed on the external surface of the pressing sleeve; and
a threaded tube connected to the pressing sleeve, disposed on the body, and having a threaded portion formed on an inner surface of the threaded tube and connected to the screwed portion of the pressing sleeve.

79. The dental tool as claimed in claim 59, wherein the cursor element has
a pressing sleeve movably mounted on the body and having
multiple cutting slices axially formed through an external surface of the pressing sleeve at spaced intervals; and
a screwed portion formed on the external surface of the pressing sleeve; and
a threaded tube connected to the pressing sleeve, disposed on the body, and having a threaded portion formed on an inner surface of the threaded tube and connected to the screwed portion of the pressing sleeve.

80. The dental tool as claimed in claim 1, wherein
the body has two rod portions;
the two rod portions are connected to each other and have different outer diameters and a stepped face is formed at a connecting location between the two rod portions; and
the measuring portion is formed on outer surfaces of the two rod portions.

81. The dental tool as claimed in claim 2, wherein
the body has two rod portions;
the two rod portions are connected to each other and have different outer diameters and a stepped face is formed at a connecting location between the two rod portions; and
the measuring portion is formed on outer surfaces of the two rod portions.

82. The dental tool as claimed in claim 3, wherein
the body has two rod portions;
the two rod portions are connected to each other and have different outer diameters and a stepped face is formed at a connecting location between the two rod portions; and
the measuring portion is formed on outer surfaces of the two rod portions.

83. The dental tool as claimed in claim 4, wherein
the body has two rod portions;
the two rod portions are connected to each other and have different outer diameters and a stepped face is formed at a connecting location between the two rod portions; and
the measuring portion is formed on outer surfaces of the two rod portions.

84. The dental tool as claimed in claim 5, wherein
the body has two rod portions;
the two rod portions are connected to each other and have different outer diameters and a stepped face is formed at a connecting location between the two rod portions; and
the measuring portion is formed on outer surfaces of the two rod portions.

85. The dental tool as claimed in claim 1, wherein
the body has two rod portions; and
the two rod portions are connected to each other and have equal outer diameters such that the body has a single outer diameter.

86. The dental tool as claimed in claim 2, wherein
the body has two rod portions; and
the two rod portions are connected to each other and have equal outer diameters such that the body has a single outer diameter.

87. The dental tool as claimed in claim 3, wherein
the body has two rod portions; and
the two rod portions are connected to each other and have equal outer diameters such that the body has a single outer diameter.

88. The dental tool as claimed in claim 4, wherein
the body has two rod portions; and
the two rod portions are connected to each other and have equal outer diameters such that the body has a single outer diameter.

89. The dental tool as claimed in claim 5, wherein
the body has two rod portions; and
the two rod portions are connected to each other and have equal outer diameters such that the body has a single outer diameter.

90. The dental tool as claimed in claim 1, wherein the working element has a curved portion formed between the connecting end and the working end.

91. The dental tool as claimed in claim 2, wherein the working element has a curved portion formed between the connecting end and the working end.

92. The dental tool as claimed in claim 3, wherein the working element has a curved portion formed between the connecting end and the working end.

93. The dental tool as claimed in claim 4, wherein the working element has a curved portion formed between the connecting end and the working end.

94. The dental tool as claimed in claim 5, wherein the working element has a curved portion formed between the connecting end and the working end.

95. The dental tool as claimed in claim 90, wherein the curved portion has an included angle.

96. The dental tool as claimed in claim 91, wherein the curved portion has an included angle.

97. The dental tool as claimed in claim 92, wherein the curved portion has an included angle.

98. The dental tool as claimed in claim 93, wherein the curved portion has an included angle.

99. The dental tool as claimed in claim 94, wherein the curved portion has an included angle.

100. The dental tool as claimed in claim 1, wherein the connecting end of the working element is arranged in a straight line with the working end.

101. The dental tool as claimed in claim 2, wherein the connecting end of the working element is arranged in a straight line with the working end.

102. The dental tool as claimed in claim 3, wherein the connecting end of the working element is arranged in a straight line with the working end.

103. The dental tool as claimed in claim 4, wherein the connecting end of the working element is arranged in a straight line with the working end.

104. The dental tool as claimed in claim 5, wherein the connecting end of the working element is arranged in a straight line with the working end.

105. The dental tool as claimed in claim 1, wherein the dental tool has
two said connecting portions respectively formed on two ends of the body; and
two said working elements respectively connected to the two said connecting portions.

106. The dental tool as claimed in claim 2, wherein
two said connecting portions respectively formed on two ends of the body; and
two said working elements respectively connected to the two said connecting portions.

107. The dental tool as claimed in claim 3, wherein
two said connecting portions respectively formed on two ends of the body; and
two said working elements respectively connected to the two said connecting portions.

108. The dental tool as claimed in claim 4, wherein
two said connecting portions respectively formed on two ends of the body; and
two said working elements respectively connected to the two said connecting portions.

109. The dental tool as claimed in claim 5, wherein
two said connecting portions respectively formed on two ends of the body; and
two said working elements respectively connected to the two said connecting portions.

110. The dental tool as claimed in claim 105, wherein the body and the two said working elements are formed as a single piece.

111. The dental tool as claimed in claim 106, wherein the body and the two said working elements are formed as a single piece.

112. The dental tool as claimed in claim 107, wherein the body and the two said working elements are formed as a single piece.

113. The dental tool as claimed in claim 108, wherein the body and the two said working elements are formed as a single piece.

114. The dental tool as claimed in claim 109, wherein the body and the two said working elements are formed as a single piece.

115. The dental tool as claimed in claim 1, wherein the body and the working element are formed as a single piece.

116. The dental tool as claimed in claim 2, wherein the body and the working element are formed as a single piece.

117. The dental tool as claimed in claim 3, wherein the body and the working element are formed as a single piece.

118. The dental tool as claimed in claim 4, wherein the body and the working element are formed as a single piece.

119. The dental tool as claimed in claim 5, wherein the body and the working element are formed as a single piece.

120. The dental tool as claimed in claim 1, wherein the body has a buffering element disposed on the connecting portion and connected to the connecting end of the working element to provide a buffering effect to the working end of the working element.

121. The dental tool as claimed in claim 2, wherein the body has a buffering element disposed on the connecting portion and connected to the connecting end of the working element to provide a buffering effect to the working end of the working element.

122. The dental tool as claimed in claim 3, wherein the body has a buffering element disposed on the connecting portion and connected to the connecting end of the working element to provide a buffering effect to the working end of the working element.

123. The dental tool as claimed in claim 4, wherein the body has a buffering element disposed on the connecting portion and connected to the connecting end of the working element to provide a buffering effect to the working end of the working element.

124. The dental tool as claimed in claim 5, wherein the body has a buffering element disposed on the connecting portion and connected to the connecting end of the working element to provide a buffering effect to the working end of the working element.

125. The dental tool as claimed in claim 120, wherein the buffering element is an elastic sheet, an end of the buffering element steadily abuts the external surface of the connecting portion, the working element is disposed in the connecting portion, and the connecting end of the working element abuts against another end of the buffering element.

126. The dental tool as claimed in claim 121, wherein the buffering element is an elastic sheet, an end of the buffering element steadily abuts the external surface of the connecting portion, the working element is disposed in the connecting portion, and the connecting end of the working element abuts against another end of the buffering element.

127. The dental tool as claimed in claim 122, wherein the buffering element is an elastic sheet, an end of the buffering element steadily abuts the external surface of the connecting portion, the working element is disposed in the connecting portion, and the connecting end of the working element abuts against another end of the buffering element.

128. The dental tool as claimed in claim 123, wherein the buffering element is an elastic sheet, an end of the buffering element steadily abuts the external surface of the connecting portion, the working element is disposed in the connecting portion, and the connecting end of the working element abuts against another end of the buffering element.

129. The dental tool as claimed in claim 124, wherein the buffering element is an elastic sheet, an end of the buffering element steadily abuts the external surface of the connecting portion, the working element is disposed in the connecting portion, and the connecting end of the working element abuts against another end of the buffering element.

130. The dental tool as claimed in claim 125, wherein
the connecting portion is detachably connected to the body and has a connecting rod formed on and protruded from an end of the connecting portion away from the working element;
the connecting rod has a thread formed on an external surface of the connecting portion; and
the body has a connecting recess connected to the connecting rod.

131. The dental tool as claimed in claim 126, wherein
the connecting portion is detachably connected to the body and has a connecting rod formed on and protruded from an end of the connecting portion away from the working element;
the connecting rod has a thread formed on an external surface of the connecting portion; and
the body has a connecting recess connected to the connecting rod.

132. The dental tool as claimed in claim 127, wherein
the connecting portion is detachably connected to the body and has a connecting rod formed on and protruded from an end of the connecting portion away from the working element;
the connecting rod has a thread formed on an external surface of the connecting portion; and
the body has a connecting recess connected to the connecting rod.

133. The dental tool as claimed in claim 128, wherein
the connecting portion is detachably connected to the body and has a connecting rod formed on and protruded from an end of the connecting portion away from the working element;
the connecting rod has a thread formed on an external surface of the connecting portion; and
the body has a connecting recess connected to the connecting rod.

134. The dental tool as claimed in claim 129, wherein
the connecting portion is detachably connected to the body and has a connecting rod formed on and protruded from an end of the connecting portion away from the working element;
the connecting rod has a thread formed on an external surface of the connecting portion; and
the body has a connecting recess connected to the connecting rod.

135. The dental tool as claimed in claim 120, wherein
the body has two rod portions with different outer diameters;
the connecting portion has a chamber;
the buffering element is mounted in the chamber and is a spring; and
the connecting end of the working element is mounted in the chamber and abuts against the buffering element.

136. The dental tool as claimed in claim 121, wherein
the body has two rod portions with different outer diameters;
the connecting portion has a chamber;
the buffering element is mounted in the chamber and is a spring; and
the connecting end of the working element is mounted in the chamber and abuts against the buffering element.

137. The dental tool as claimed in claim 122, wherein
the body has two rod portions with different outer diameters;
the connecting portion has a chamber;
the buffering element is mounted in the chamber and is a spring; and
the connecting end of the working element is mounted in the chamber and abuts against the buffering element.

138. The dental tool as claimed in claim 123, wherein
the body has two rod portions with different outer diameters;
the connecting portion has a chamber;
the buffering element is mounted in the chamber and is a spring; and
the connecting end of the working element is mounted in the chamber and abuts against the buffering element.

139. The dental tool as claimed in claim 124, wherein
the body has two rod portions with different outer diameters;
the connecting portion has a chamber;
the buffering element is mounted in the chamber and is a spring; and
the connecting end of the working element is mounted in the chamber and abuts against the buffering element.

140. The dental tool as claimed in claim 135, wherein
the connecting portion is detachably connected to the body and has a connecting rod formed on and protruded from an end of the connecting portion away from the working element;
the connecting rod has a thread formed on an external surface of the connecting portion; and
the body has a connecting recess connected to the connecting rod.

141. The dental tool as claimed in claim 136, wherein
the connecting portion is detachably connected to the body and has a connecting rod formed on and protruded from an end of the connecting portion away from the working element;
the connecting rod has a thread formed on an external surface of the connecting portion; and
the body has a connecting recess connected to the connecting rod.

142. The dental tool as claimed in claim 137, wherein
the connecting portion is detachably connected to the body and has a connecting rod formed on and protruded from an end of the connecting portion away from the working element;
the connecting rod has a thread formed on an external surface of the connecting portion; and
the body has a connecting recess connected to the connecting rod.

143. The dental tool as claimed in claim 138, wherein
the connecting portion is detachably connected to the body and has a connecting rod formed on and protruded from an end of the connecting portion away from the working element;
the connecting rod has a thread formed on an external surface of the connecting portion; and
the body has a connecting recess connected to the connecting rod.

144. The dental tool as claimed in claim 139, wherein
the connecting portion is detachably connected to the body and has a connecting rod formed on and protruded from an end of the connecting portion away from the working element;
the connecting rod has a thread formed on an external surface of the connecting portion; and
the body has a connecting recess connected to the connecting rod.

145. The dental tool as claimed in claim 135, wherein
the connecting portion of the body has a cover disposed below the chamber;
the working element has an annular flange formed between the connecting end and the working end and disposed in the chamber; and
the annular flange abuts the cover and the buffering element.

146. The dental tool as claimed in claim 136, wherein
the connecting portion of the body has a cover disposed below the chamber;
the working element has an annular flange formed between the connecting end and the working end and disposed in the chamber; and
the annular flange abuts the cover and the buffering element.

147. The dental tool as claimed in claim 137, wherein
the connecting portion of the body has a cover disposed below the chamber;
the working element has an annular flange formed between the connecting end and the working end and disposed in the chamber; and
the annular flange abuts the cover and the buffering element.

148. The dental tool as claimed in claim 138, wherein
the connecting portion of the body has a cover disposed below the chamber;
the working element has an annular flange formed between the connecting end and the working end and disposed in the chamber; and
the annular flange abuts the cover and the buffering element.

149. The dental tool as claimed in claim 139, wherein
the connecting portion of the body has a cover disposed below the chamber;
the working element has an annular flange formed between the connecting end and the working end and disposed in the chamber; and
the annular flange abuts the cover and the buffering element.

150. The dental tool as claimed in claim 145, wherein
the connecting portion is detachably connected to the body and has a connecting rod formed on and protruded from an end of the connecting portion away from the working element;
the connecting rod has a thread formed on an external surface of the connecting portion; and
the body has a connecting recess connected to the connecting rod.

151. The dental tool as claimed in claim 146, wherein
the connecting portion is detachably connected to the body and has a connecting rod formed on and protruded from an end of the connecting portion away from the working element;
the connecting rod has a thread formed on an external surface of the connecting portion; and
the body has a connecting recess connected to the connecting rod.

152. The dental tool as claimed in claim 147, wherein
the connecting portion is detachably connected to the body and has a connecting rod formed on and protruded from an end of the connecting portion away from the working element;
the connecting rod has a thread formed on an external surface of the connecting portion; and
the body has a connecting recess connected to the connecting rod.

153. The dental tool as claimed in claim 148, wherein
the connecting portion is detachably connected to the body and has a connecting rod formed on and protruded from an end of the connecting portion away from the working element;
the connecting rod has a thread formed on an external surface of the connecting portion; and
the body has a connecting recess connected to the connecting rod.

154. The dental tool as claimed in claim 149, wherein
the connecting portion is detachably connected to the body and has a connecting rod formed on and protruded from an end of the connecting portion away from the working element;
the connecting rod has a thread formed on an external surface of the connecting portion; and
the body has a connecting recess connected to the connecting rod.
